(19) United States
(12) Patent Application Publication
(10) Pub. No.: US 2023/0097433 A1
(43) Pub. Date: Mar. 30, 2023

(54) HEAD-MOUNTED DEVICE

(71) Applicant: SONY GROUP CORPORATION, TOKYO (JP)

(72) Inventor: TOSHIMI KOBAYASHI, TOKYO (JP)

(21) Appl. No.: 17/908,584

(22) PCT Filed: Mar. 2, 2021
(86) PCT No.: PCT/JP2021/007811

§ 371 Date: Sep. 1, 2022

(30) Foreign Application Priority Data
Mar. 10, 2020 (JP) 2020-041177

(51) Int. Cl. G02B 27/01

(52) U.S. Cl. CPC G02B 27/0176

(57) ABSTRACT

A head-mounted device according to the present technology includes a front block, a mounting band, a first elastic member, and a second elastic member. The front block is mounted on a front side of a head. The mounting band includes a pair of left and right band portions that are mounted on left and right sides of the head and a rear block that is mounted on a rear side of the head and movable relative to the pair of band portions, the mounting band being capable of extending and contracting due to the movement of the rear block relative to the pair of band portions. The pair of left and right first elastic members are a pair of left and right members that generate tensile force to cause the mounting band to contract. The pair of left and right second elastic members are a pair of left and right members provided between the front block and the pair of band portions.

### TECHNICAL FIELD

The present technology relates to a head-mounted device to be mounted on a user's head.

### BACKGROUND ART

In recent years, head-mounted displays capable of AR display (AR: Augmented Reality) or VR display (VR: Virtual Reality) are becoming widely known.

The head-mounted displays need a mechanism for mounting a user's head. For example, a head-mounted display described in Patent Literature 1 below is a head-mounted display including a main body including a display and a mounting band for mounting the head-mounted display to a user's head.

### CITATION LIST

### Patent Literature

Patent Literature 1: WO2016/136657

### DISCLOSURE OF INVENTION

### Technical Problem

In such a field, it is desirable to provide a technology capable of facilitating the adjustment of clamping force on a head.

In view of the above-mentioned circumstances, it is an objective of the present technology to provide a head-mounted device capable of facilitating the adjustment of clamping force on a head.

### Solution to Problem

A head-mounted device according to the present technology includes a front block, a mounting band, a first elastic member, and a second elastic member.

The front block is mounted on a front side of a head.

The mounting band includes a pair of left and right band portions that are mounted on left and right sides of the head and a rear block that is mounted on a rear side of the head and movable relative to the pair of band portions, the mounting band being capable of extending and contracting due to the movement of the rear block relative to the pair of band portions.

The pair of left and right first elastic members are a pair of left and right members that generate tensile force to cause the mounting band to contract.

The pair of left and right second elastic members are a pair of left and right members provided between the front block and the pair of band portions.

In this head-mounted device, since two kinds of elastic members are used, the adjustment of clamping force on a head can be facilitated.

In the head-mounted device, the pair of first elastic members may be provided between the pair of band portions and the rear block.

In the head-mounted device, the pair of first elastic members may be provided between the front block and the rear block.

In the head-mounted device, a spring constant of the first elastic member may be different from a spring constant of the second elastic member.

In the head-mounted device, the spring constant of the second elastic member may be higher than the spring constant of the first elastic member.

In the head-mounted device, the spring constant of the second elastic member may be twice or more as large as the spring constant of the first elastic member.

In the head-mounted device, the rear block may include a lock mechanism that switches between an unlocked state in which the extension and contraction of the mounting band due to the movement of the rear block relative to the pair of band portions are allowed and a locked state in which the extension and contraction of the mounting band due to the relative movement are restricted.

In the head-mounted device, the rear block may include an operation unit for causing the mounting band to extend and contract, and the lock mechanism may switch the unlocked state to the locked state in accordance with an operation of the operation unit.

In the head-mounted device, the lock mechanism may include a restriction member that allows, in the locked state, the extension and contraction of the mounting band that are performed in accordance with an operation of the operation unit while restricting the extension and contraction of the mounting band that are not performed in accordance with an operation of the operation unit.

In the head-mounted device, the operation unit may include a rotatable dial and the head-mounted device may further include an extension and contraction mechanism that includes a pinion gear rotatable in accordance with a rotation of the dial and racks, which are respectively provided in the pair of band portions and engaged with the pinion gear, and causes the mounting band to extend and contract in accordance with a rotation of the dial.

In the head-mounted device, the restriction member may restrict, in the locked state, the rotation of the pinion gear to thereby restrict the extension and contraction of the mounting band during non-rotation of the dial and allow the rotation of the pinion gear to thereby allow the extension and contraction of the mounting band during rotation of the dial.

In the head-mounted device, the lock mechanism may further include a clutch that is capable of being engaged with the restriction member, is located at a first position not engaged with the restriction member and allows the rotation of the pinion gear in the unlocked state, and moves from the first position to a second position, is engaged with the rotation restriction member in accordance with a rotation of the dial in the unlocked state, and switches the unlocked state to the locked state.

In the head-mounted device, the lock mechanism may further include a switching mechanism that moves the clutch from the first position to the second position in accordance with a rotation of the dial.

In the head-mounted device, the clutch may be rotatable integrally with the pinion gear, the restriction member may be rotatable integrally with the clutch in a state engaged with the clutch, and the dial may be capable of rotating the rotation restriction member by rotation.

In the head-mounted device, the lock mechanism may further include a tooth portion provided in the rear block, and the restriction member may include a hook portion that is engaged with the tooth portion, restricts the extension and contraction of the mounting band in such a manner that the rotation of the restriction member is restricted in an engaged state in which the hook portion is engaged with the tooth portion, and allows the extension and contraction of the mounting band in such a manner that the rotation of the restriction member is allowed in a cancelled state in which the engagement is cancelled.

In the head-mounted device, the lock mechanism may further include a cancel mechanism that puts the hook portion in the engaged state during non-rotation of the dial and puts the hook portion in the cancelled state during rotation of the dial.

The head-mounted device may further include: an inertial sensor that acquires inertial information of a gravity direction; a drive unit that generates driving force to cause the mounting band to extend and contract; and a control unit that controls the drive unit on the basis of the inertial information to cause the mounting band extend and contract.

In the head-mounted device, the head-mounted device may further include: a worm drive provided in a drive unit; and a worm wheel that is engaged with the worm drive and causes the mounting band to extend and contract by rotation.

A head-mounted device according to another aspect of the present technology includes a front block, a mounting band, an operation unit, a link member, and an elastic member.

The front block is mounted on a front side of a head.

The mounting band includes a pair of left and right band portions that are mounted on left and right sides of the head and a rear block that is mounted on a rear side of the head and movable relative to the pair of band portions, the mounting band being capable of extending and contracting due to the movement of the rear block relative to the pair of band portions.

The operation unit is provided in the front block.

The pair of left and right link members are movable along the pair of band portions in accordance with an operation of the operation unit.

The pair of left and right elastic members are provided between the pair of link members and the rear block.

A head-mounted device according to a still another aspect of the present technology includes a mounting band, an inertial sensor, a drive unit, and a control unit.

The mounting band is capable of extending and contracting.

The inertial sensor acquires inertial information of a gravity direction.

The drive unit generates driving force to cause the mounting band to extend and contract.

The control unit controls the drive unit on the basis of the inertial information to cause the mounting band extend and contract.

### BRIEF DESCRIPTION OF DRAWINGS

FIG. 1 A perspective view as an HMD according to a first embodiment of the present technology is viewed from obliquely behind.

FIG. 2 A schematic diagram as the HMD is viewed from above.

FIG. 3 An exploded perspective view as respective parts in a rear portion of a rear block main body are viewed from a rear side.

FIG. 4 An exploded perspective view as the respective parts in the rear portion of the rear block main body are viewed from a front side.

FIG. 5 A schematic cross-sectional view of the respective parts in the rear portion of the rear block main body in a horizontal plane (XY-plane), which is a diagram showing switching between an unlocked state and a locked state.

FIG. 6 A schematic diagram as a rotation restriction member is viewed from the rear side.

FIG. 7 A diagram showing engagement of tooth portions in the rear block main body with the rotation restriction member, which is a schematic diagram as these members are viewed from the rear side.

FIG. 8 A diagram showing a dial and lock levers, which is a schematic diagram as these members are viewed from the rear side.

FIG. 9 A schematic diagram showing a state when the HMD is temporarily mounted on each head.

FIG. 10 A schematic diagram showing a state when clamping force of the entire HMD on each head is adjusted by rotating the dial.

FIG. 11 A diagram showing a relationship between the clamping force of the entire HMD and a head length (length in the Y-axis direction) in the unlocked state.

FIG. 12 A schematic diagram showing a state when an HMD according to a second embodiment is temporarily mounted on each head in an unlocked state.

FIG. 13 A schematic diagram showing a state when clamping force of the entire HMD on each head is adjusted by rotating a dial in a locked state.

FIG. 14 A schematic diagram showing a state when the clamping force of the entire HMD on each head is adjusted in an HMD according to a third embodiment.

FIG. 15 An exploded perspective view as respective parts in a rear portion of a rear block main body are viewed from a rear side in an HMD according to a fourth embodiment.

FIG. 16 A schematic diagram as the HMD is viewed from above.

FIG. 17 A block diagram showing an electrical configuration of the HMD.

FIG. 18 A flowchart showing processing of a control unit.

FIG. 19 A diagram showing an example in a case where the clamping force of the entire HMD is automatically adjusted in accordance with acceleration in a gravity direction.

FIG. 20 An exploded perspective view as respective parts in a rear portion of a rear block main body are viewed from a rear side in an HMD according to a fifth embodiment.

### MODE(S) FOR CARRYING OUT THE INVENTION

Hereinafter, embodiments according to the present technology will be described with reference to the drawings.

### First Embodiment

<Overall Configuration and Configurations of Respective Parts>

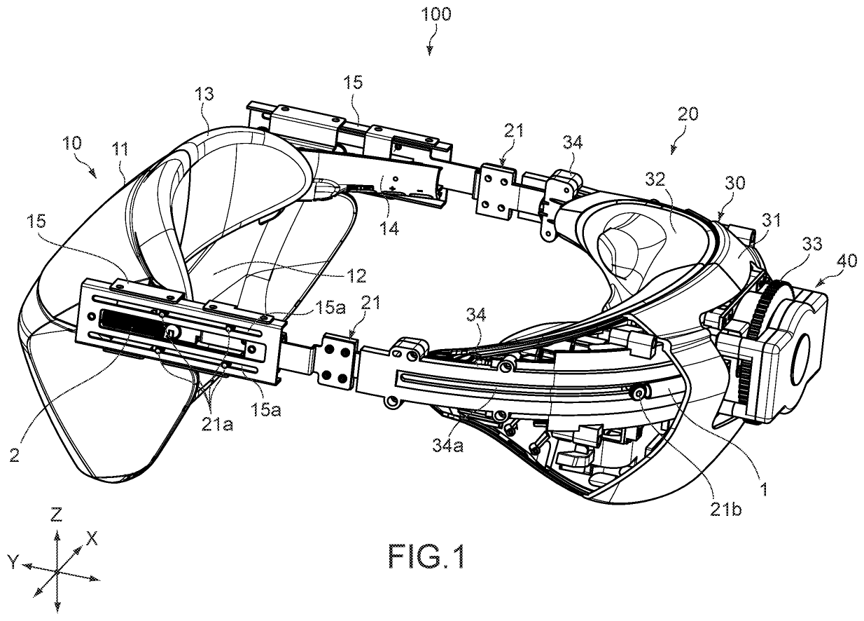

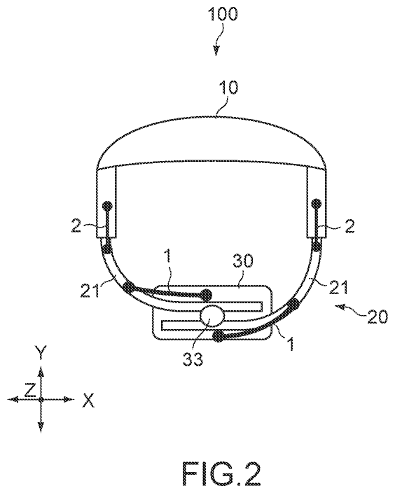

FIG. 1 is a perspective view as a head-mounted display (HMD) 100 according to a first embodiment of the present technology is viewed from obliquely behind. In FIG. 1, a rear part of the HMD 100 is represented, partially broken. FIG. 2 is a schematic diagram as the HMD 100 is viewed from above. It should be noted that in each of the figures in the present specification, the X-axis direction denotes a left-right direction, the Y-axis direction denotes a front-rear direction, and the Z-axis direction denotes an upper-lower direction.

In the description of the embodiment, the HMD 100 will be described as an example of a head-mounted device to which a mounting mechanism according to the present technology is applied. On the other hand, the head-mounted device is not limited to the HMD. For example, the head-mounted device may be an electroencephalographic (EEG) measurement device for measuring brain waves or may be headphones. Typically, the head-mounted device can be any device as long as it is a device wearable on a user's head.

As shown in FIGS. 1 and 2, the HMD 100 generally has an annular shape and is mounted to cover the entire periphery of the user's head (around the Z-axis).

The HMD 100 includes a front block 10 that is mounted on a front side of the user's head and a mounting band 20 that is mounted from the sides to the back of the user's head. Moreover, the HMD 100 includes a pair of left and right first spring members 1 that generate tensile force to cause the mounting band 20 to contract and a pair of left and right second spring members 2 capable of pulling a pair of band portions 21 of the mounting band 20 toward the front block 10.

It should be noted that although springs will be described as an example of elastic materials used for a first elastic member and a second elastic member in the description of each embodiment, the elastic materials are not limited to the springs and may be rubbers or the like.

[Front Block 10]

The front block 10 includes a front block main body 11, a display unit 12 provided on an inner peripheral side of the front block main body 11, and a forehead pad 13 provided on an upper side on the inner peripheral side of the front block main body 11. Moreover, the front block 10 includes a pair of left and right fixing portions 14 provided on the sides of both left and right ends in the front block main body 11 and a pair of left and right coupling portions 15 fixed to the pair of fixing portions 14.

The front block main body 11 is formed, curved at a predetermined curvature (around the Z-axis) to be easily mounted on the head. The front block main body 11 is made from, for example, resin, metal, or the like.

The display unit 12 is constituted by, for example, a liquid-crystal display, an electro-luminescence (EL) display, or the like. The display unit 12 is capable of performing VR display or AR display.

The forehead pad 13 is made from cloth, leather, or the like, and the position of forehead pad 13 is set to come into contact with the forehead when the user wears the HMD.

The pair of fixing portions 14 are provided extending rearward from the both end portions at the left and right of the front block main body 11.

The pair of coupling portions 15 are fixed to the pair of fixing portions 14. The pair of coupling portions 15 are members for coupling the mounting band 20 to the front block 10. The coupling portions 15 are constituted by thin plate shapes and are capable of housing therein the second spring members 2 and front end portions of the band portions 21. The coupling portions 15 are made from, for example, resin, metal, or the like.

The coupling portion 15 has two guide grooves 15a provided in the front-rear direction at the upper and lower positions. The two guide grooves 15a are capable of guiding four protrusions 21a provided at each of the front end portions of the band portions 21 in the front-rear direction, and accordingly, the coupling portions 15 are capable of guiding the front end portions of the band portions 21 in the front-rear direction.

[Mounting Band 20]

The mounting band 20 is configured to surround the sides of the head and the back of the head. The mounting band 20 includes a pair of left and right band portions 21 that are mounted on left and right sides of the head and a rear block 30 that is mounted to the rear side of the head and movable relative to the pair of band portions 21.

The mounting band 20 is capable of extending and contracting equally on the left and right sides due to the movement of the rear block 30 relative to the pair of band portions 21. Moreover, the mounting band 20 is capable of extending and contracting equally on the left and right sides due to the rotation of a dial 33 provided in the rear block 30.

“Rear Block 30”

The rear block 30 includes a rear block main body 31 and a cushion portion 32 on an inner peripheral side of the rear block main body 31. The rear block main body 31 is configured as a casing capable of housing the respective parts therein. The rear block main body 31 is formed, curved at a predetermined curvature (around the Z-axis) to be easily mounted on the user's head. The rear block main body 31 is made from, for example, resin, metal, or the like. The cushion portion 32 is provided to come into contact with the user's head, and this cushion portion 32 is made from, for example, cloth, leather, or the like.

Moreover, the rear block 30 includes the dial 33 that is a rotational operation unit. The dial 33 is provided at a position near the middle in the left-right direction and upper in the upper-lower direction on an outer peripheral side of the rear block 30. Moreover, the rear block 30 includes a lock mechanism 40 at a position corresponding to the dial 33.

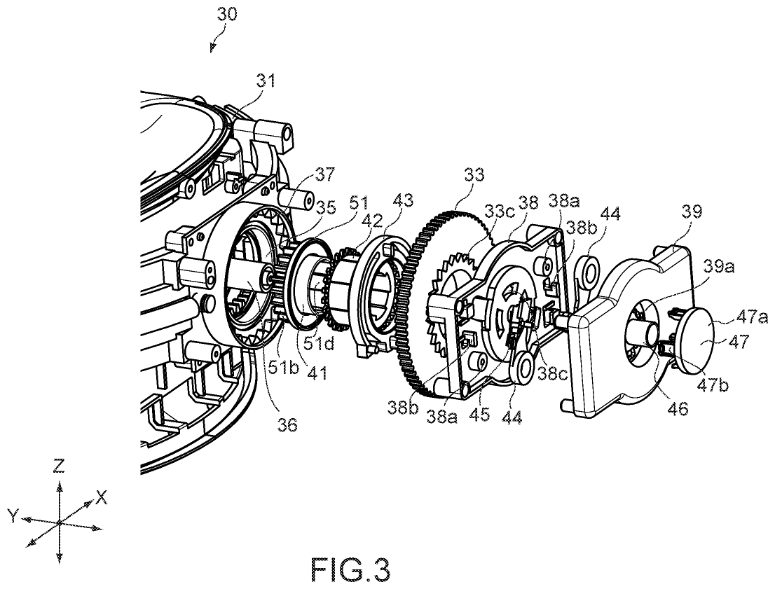

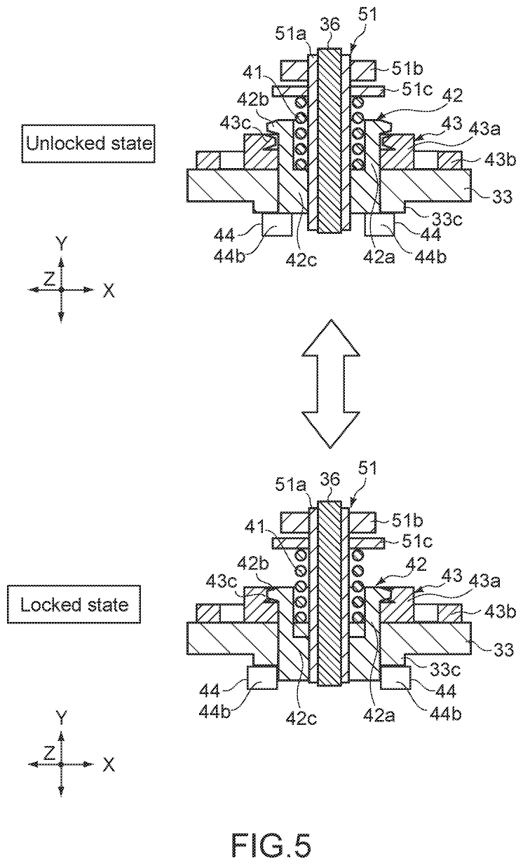

The dial 33 is rotatable in both the clockwise and counter-clockwise directions (as viewed from the rear side) around the axis in the front-rear direction. On the side of the rear block main body 31, there is provided a pinion gear 51b (see FIG. 3, FIG. 5, and the like) rotatable in accordance with a rotation of the dial 33 (in a locked state). Moreover, the pair of band portions 21 are each provided with a rack that is engaged with the pinion gear 51b. It should be noted that the pinion gear 51b and the racks constitute an extension and contraction mechanism that causes the mounting band to extend and contract 20 in accordance with a rotation of the dial 33.

The dial 33 is capable of causing the mounting band 20 to extend and contract due to the operation of the extension and contraction mechanism (the pinion gear 51b and the racks) by the rotation thereof. It should be noted that in this embodiment, the extension and contraction of the mounting band 20 according to a rotation of the dial 33 (operation of the operation unit) mean that the pinion gear 51b rotates in accordance with a rotation of the dial 33, the pair of band portions 21 provided with the racks each move in this manner, and the mounting band 20 extends and contracts accordingly.

In this embodiment, the dial 33 is capable of causing the mounting band 20 to contract by clockwise rotation (viewed from the back side) and is capable of causing the mounting band 20 to extend by counter-clockwise rotation (viewed from the back side) (the relationship between the direction of rotation and the extension and contraction may be opposite).

The lock mechanism 40 is capable of switching between an unlocked state in which the extension and contraction of the mounting band 20 due to the movement of the rear block 30 relative to the pair of band portions 21 are allowed and a locked state in which the extension and contraction of the mounting band 20 due to the relative movement are restricted. Moreover, the lock mechanism 40 is capable of switching the unlocked state to the locked state in accordance with a rotation of the dial 33 (operation of the operation unit). That is, the lock mechanism 40 switches the unlocked state to the locked state, using the rotation of the dial 33 as a trigger.

Moreover, in this embodiment, in particular, the lock mechanism 40 is capable of allowing, in the locked state, the extension and contraction of the mounting band 20 that are performed in accordance with a rotation of the dial 33 while restricting the extension and contraction of the mounting band 20 that are not performed in accordance with a rotation of the dial 33 (operation of the operation unit).

It should be noted that specific configurations of the dial 33, the lock mechanism 40, and the like provided in a rear portion of the rear block 30 will be described later in detail with reference to FIGS. 3 to 8 and the like.

The rear block 30 includes therein a pair of left and right guide portions 34 that guide the pair of band portions 21. The pair of guide portions 34 are provided to extend from the left and right end portion sides of the rear block 30 to the rear portion side (the position corresponding to the dial 33), and each have a thin plate shape long in one direction.

The guide portions 34 have a guide groove 34a at a position near the middle in the upper-lower direction, the guide groove 34a extending in the length direction (direction in which the mounting band 20 extends and contracts). The guide groove 34a is capable of being fitted to the protrusion 21a provided protruding outward on the band portions 21.

“Band Portion 21”

The band portions 21 each have a configuration like a thin plate long in one direction, and are constituted by materials having relatively high rigidity, such as resin and metal, for example.

The racks that are engaged with the pinion gear 51b are provided in certain regions on the sides of rear end portions of the band portions 21.

One end portions of the second spring members 2 are fixed to the front end portions of the band portions 21. The other end portions of the second spring members 2 are fixed to the coupling portions 15 of the front block 10, and therefore the band portions 21 are coupled to the front block 10 via the second spring members 2.

On the sides of the front end portions of the band portions 21, a total of four protrusions 21a, two on the upper side and two on the lower side, which protrude outward, are provided. These four protrusions 21a can be guided through the two guide grooves 15a provided in the front-rear direction at the coupling portions 15, and accordingly the band portions 21 can be guided in the front-rear direction through the coupling portions 15.

A single protrusion 21b that protrudes outward is provided at a position near the middle in the longitudinal direction and the upper-lower direction of the band portion 21. This protrusion 21b can be guided through the guide groove 34a provided in the guide portion 34 of the rear block 30, and accordingly the band portion 21 can be guided in extension and contraction directions inside the rear block 30.

One end portion of the first spring member 1 is fixed to this protrusion 21b. The other end portion of the first spring member 1 is fixed to the rear block 30, and therefore the band portion 21 is coupled to the rear block 30 via the first spring member 1. It should be noted that the protrusion 21b has two functions, a function to be guided in the guide groove 34a and a function to fix one end of the first spring member 1.

“First Spring Member 1”

The first spring members 1 have the one end portions fixed to the protrusions 21b of the band portions 21 and the other end portions fixed to the positions near the middle in the left-right direction in the rear block 30. That is, the first spring members 1 are provided between the band portions 21 and the rear block 30. These first spring members 1 are capable of pulling the rear block 30 toward the front block 10 and capable of causing the mounting band 20 to contract in the unlocked state. It should be noted that in the first embodiment, the first spring members 1 do not work in the locked state.

“Second Spring Member 2”

The second spring members 2 have the one end portions fixed to the front end portions of the band portions 21 and the other end portions fixed to front end portions of the coupling portions 15 in the front block 10. That is, the second spring members 2 are provided between the band portions 21 and the front block 10. These second spring members 2 are capable of pulling the pair of band portions 21 (mounting 2 band 20) toward the front block 10 in the unlocked state and the locked state.

Here, in this embodiment, the spring constant of the first spring member 1 and the spring constant of the second spring member 2 are different, and in particular, the spring constant of the second spring member 2 is set to take a value larger than that of the spring constant of the first spring member 1. Typically, the spring constant of the second spring member 2 is set to be twice or more as large as the spring constant of the first spring member 1. Moreover, the initial load when the second spring member 2 starts to extend is set to take a value larger than the initial load when the first spring member 1 starts to extend. It should be noted that the values of the spring constant and the initial load will be described later in detail.

[Lock Mechanism 40]

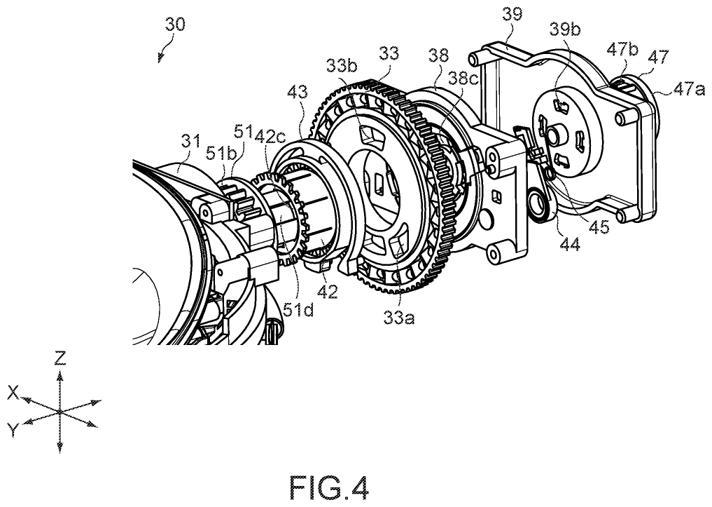

Next, the respective parts such as the dial 33 and the lock mechanism 40 provided in the rear portion of the rear block main body 31 will be described in detail. FIG. 3 is an exploded perspective view as the respective parts in the rear portion of the rear block main body 31 are viewed from the rear side. FIG. 4 is an exploded perspective view as the respective parts in the rear portion of the rear block main body 31 are viewed from the front side. FIG. 5 is a schematic cross-sectional view of the respective parts in the rear portion of the rear block main body 31 in a horizontal plane (XY-plane), which is a diagram showing switching between the unlocked state and the locked state.

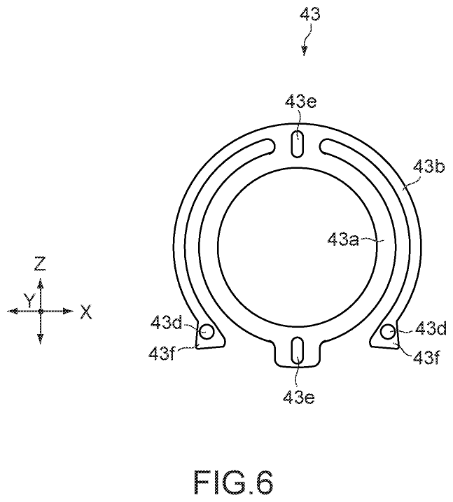

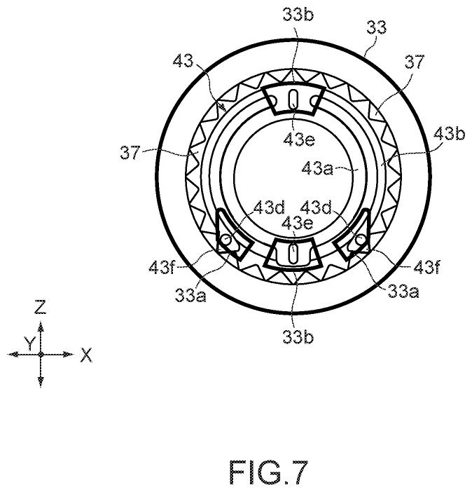

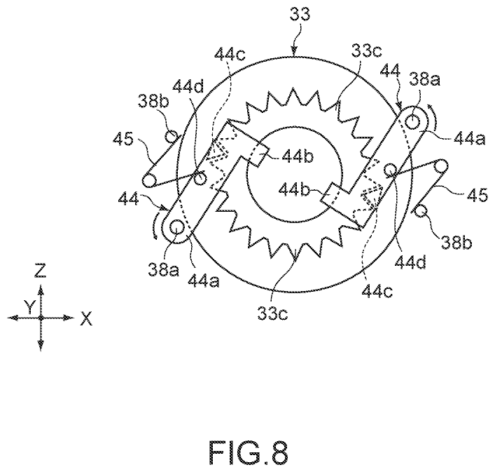

FIG. 6 is a schematic diagram as a rotation restriction member 43 is viewed from the rear side. FIG. 7 is a diagram showing engagement of tooth portions 37 in the rear block main body 31 with the rotation restriction member 43, which is a schematic diagram as these members are viewed from the rear side. It should be noted that in FIG. 7, the dial 33 on the front side is represented as the thick solid line and this dial 33 is shown in a see-through state. FIG. 8 is a diagram showing the dial 33 and lock levers 44, which is a schematic diagram as these members are viewed from the rear side. It should be noted that in FIG. 8, a first base 38 is omitted.

In the description of the respective parts provided in the rear portion of the rear block main body 31, a direction around the axis of the front-rear direction (Y-axis direction) is defined as a circumferential direction and a direction perpendicular to the front-rear direction (Y-axis direction) is defined as a radial direction. Moreover, the inside in the radial direction is defined as an inner peripheral side and the outside in the radial direction is defined as an outer peripheral side. Moreover, the “clockwise and counter-clockwise directions” refer to directions of rotation when the respective parts are viewed from the rear side.

Referring to FIGS. 3 and 4, the rear portion of the rear block main body 31 is provided with a circular opening 35. At the position of this opening 35, a pinion gear portion 51, a first biasing spring 41, a clutch 42, the rotation restriction member 43 (restriction member), the dial 33 (operation unit), the first base 38, the pair of lock levers 44, a pair of torsion springs 45, a second base 39, a second biasing spring 46, and a cancel button 47 are assembled and mounted in order from the front side.

The rear block main body 31 includes, at a position of the middle in the opening 35, a shaft portion 36 extending in the front-rear direction. This shaft portion 36 is fixed to the rear block main body 31 and capable of supporting the pinion gear portion 51 as the shaft. Moreover, the rear block main body 31 includes, in a circular inner circumferential surface formed by the opening 35, the plurality of tooth portions 37 formed like a V-shaped gear in the entire periphery (also see FIG. 7). The plurality of tooth portions 37 is capable of locking the rotation restriction member 43.

It should be noted that in this embodiment, the lock mechanism 40 includes the clutch 42, the first biasing spring 41, the rotation restriction member 43, the lock levers 44, the torsion springs 45, the second biasing spring 46, the cancel button 47, the tooth portions 37 of the rear block main body 31, and the like.

“Pinion Gear Portion 51”

Referring to FIGS. 3 to 5, the pinion gear portion 51 is configured to be rotatable in both the clockwise and counter-clockwise directions around the axis in the front-rear direction. The pinion gear portion 51 includes a circular tube portion 51a, the pinion gear 51b fixed to an outer periphery of the tube portion 51a, and a flange 51c fixed to the outer periphery of the tube portion 51a.

The tube portion 51a of the pinion gear portion 51 is mounted on the shaft portion 36 of the rear block main body 31 via a bearing, and is rotatable around the shaft portion 36. The tube portion 51a of the pinion gear portion 51 includes a plurality of guide grooves 51d extending in the front-rear direction at constant intervals in the circumferential direction in the outer circumferential surface. The plurality of guide grooves 51d is capable of guiding a plurality of depressed portions 42c provided in the clutch 42 in the front-rear direction.

The pinion gear 51b is provided on the front side of the tube portion 51a of the pinion gear portion 51. The pinion gear 51b is capable of being engaged with the racks provided in the pair of band portions 21 and is capable of causing the pair of band portions 21 to extend and contract by the rotation thereof.

The flange 51c is provided at a position at the back of the pinion gear 51b on the front side of the tube portion 51a of the pinion gear portion 51. This flange 51c is capable of locking one end portion of the first biasing spring 41 interposed between the pinion gear portion 51 and the clutch 42.

“Clutch 42”

Referring to FIGS. 3 to 5, the clutch 42 is rotatable integrally with the pinion gear portion 51, and is slidable in the front-rear direction with respect to the pinion gear portion 51. Moreover, the clutch 42 is capable of being engaged with the rotation restriction member 43.

In the unlocked state, this clutch 42 is located at a non-working position (first position) not engaged with the rotation restriction member 43 and allows the rotation of the pinion gear 51b (see on the upper side of FIG. 5). Moreover, the clutch 42 moves from the non-working position to a working position (second position) engaged with the rotation restriction member 43 in accordance with a rotation of the dial 33 in the unlocked state and switches the unlocked state to the locked state (see on the lower side of FIG. 5).

The clutch 42 includes a circular tube portion 42a, a plurality of external tooth portions 42b like a gear provided in an outer circumferential surface of the tube portion 42a, and the plurality of depressed portions 42c provided in an inner circumferential surface of the tube portion 42a. The tube portion 42a of the clutch 42 is configured to have a diameter larger than that of the tube portion 51a of the pinion gear portion 51, and the clutch 42 is mounted to cover the circumference of the pinion gear portion 51.

The plurality of external tooth portions 42b is formed at positions on a front end portion of the tube portion 42a of the clutch 42 so as to protrude from the outer circumferential surface of the tube portion 42a. The plurality of external tooth portions 42b is capable of being engaged with internal tooth portions 43c provided in the rotation restriction member 43.

The plurality of depressed portions 42c is formed at positions on the rear side in the tube portion 42a of the clutch 42 so as to protrude from the inner circumferential surface of the tube portion 42a. The plurality of depressed portions 42c is formed extending in the front-rear direction at constant intervals in the circumferential direction. Since the plurality of depressed portions 42c of the clutch 42 is engaged with the plurality of guide grooves 51d of the pinion gear portion 51, the clutch 42 is slidable in the front-rear direction with respect to the pinion gear portion 51 while the rotation with respect to the pinion gear portion 51 is restricted (i.e., rotatable integrally with the pinion gear portion 51). It should be noted that front surfaces of the plurality of depressed portions 42c are capable of locking the other end portion of the first biasing spring 41.

“First Biasing Spring 41”

The first biasing spring 41 is interposed between the pinion gear portion 51 and the clutch 42 and capable of biasing the clutch 42 toward the rear side (toward the working position from the non-working position). The one end portion of the first biasing spring 41 is locked with the flange 51c of the pinion gear portion 51 and the other end portion is locked with the plurality of depressed portions 42c of the clutch 42.

Although in the description here, the springs are exemplified as the first biasing members that bias the clutch 42 toward the rear side (toward the working position from the non-working position), the first biasing members are not limited to the springs, and may be elastic materials such as rubbers. The same applies to the second biasing spring.

“Rotation Restriction Member 43”

Referring to FIGS. 3 to 7, the rotation restriction member 43 includes an annular ring portion 43a positioned on the inner peripheral side and a U-shaped U-portion 43b that is located on the outer peripheral side and formed like a partially cut annular ring. The U-portion 43b is formed to be concentric with the ring portion 43a, and is connected with the ring portion 43b at the center position in the circumferential direction.

The ring portion 43a includes the plurality of gear-like internal tooth portions 43c in the entire periphery at a front position in the inner circumferential surface. The internal tooth portions 43c are capable of being engaged with the external tooth portions 42b in the clutch 42. Moreover, the ring portion 43a includes a pair of second ribs 43e at a position connected to the U-portion 43b and a position on the opposite side of that position across the center of the ring portion 43a. The pair of second ribs 43e are provided to protrude toward the rear side (the side of the dial 33) in a rear surface of the ring portion 43a. The pair of second ribs 43e are capable of being engaged with a pair of second groove portions 33b provided in the dial 33.

The U-portion 43b includes, at the both end portions thereof, a pair of hook portions 43f and a pair of first ribs 43d. The pair of hook portions 43f are provided to protrude toward the outer peripheral side. The pair of hook portions 43f are formed in a V-shape and capable of being engaged with the V-shaped tooth portions 37 formed in the opening 35 of the rear block main body 31. The pair of hook portions 43f are biased toward the outer peripheral side in the state engaged with the tooth portions 37, using the point connected to the ring portion 43a as the support point.

The pair of first ribs 43d are provided to protrude toward the rear side (the side of the dial 33) at positions in the rear surface of the U-portion 43b, which correspond to the pair of hook portions 43f. The pair of first ribs 43d are capable of being engaged with a pair of first groove portions 33a provided in the dial 33.

Although the rotation restriction member 43 is rotatable in both the clockwise and counter-clockwise directions (as viewed from the rear side) around the axis in the front-rear direction, the rotation in one direction of the clockwise and counter-clockwise directions is restricted in the engaged state in which one hook portion 43f of the pair of hook portions 43f is engaged with the tooth portions 37.

Giving the description with reference to FIG. 7, the clockwise rotation is restricted when the hook portion 43f on the right side in FIG. 7 is engaged with the tooth portions 37. It should be noted that the hook portion 43f on the left side in FIG. 7 does not prevent the clockwise rotation. Moreover, when the hook portion 43f on the left side in FIG. 7 is engaged with the tooth portions 37, the counter-clockwise rotation is restricted. It should be noted that the hook portion 43f on the right side in FIG. 7 does not prevent the counter-clockwise rotation.

The rotation restriction member 43 is integral with the clutch 42 (rotatable integrally with the clutch 42) in the direction of rotation in a state in which the clutch 42 is located at the working position and the rotation restriction member 43 and the clutch 42 are engaged with each other, i.e., in the locked state (on the lower side of FIG. 5). Moreover, in the locked state, in the engaged state in which the hook portions 43f of the rotation restriction member 43 are engaged with the tooth portions 37 of the rear block main body 31, a restricted state in which the rotation of the rotation restriction member 43 is restricted is achieved.

Therefore, in the restricted state in which the rotation of the rotation restriction member 43 is restricted, the rotation of the clutch 42 integral with the rotation restriction member 43 in the direction of rotation is also restricted. Thus, in this case, since the rotation of the pinion gear portion 51 integral with the clutch 42 in the direction of rotation is also restricted, the extension and contraction of the mounting band 20 are restricted.

On the other hand, in the locked state, in a cancelled state in which the engaged state of the hook portions 43f of the rotation restriction member 43 with the tooth portions 37 of the rear block main body 31 is cancelled, a non-restricted state in which the rotation of the rotation restriction member 43 is not restricted. In this case, when the rotation restriction member 43 rotates, the clutch 42 integral with the rotation restriction member 43 in the direction of rotation rotates and the pinion gear 51b integral with the clutch 42 in the direction of rotation rotates, and therefore the mounting band 20 extends and contracts.

That is, the rotation restriction member 43 restricts the extension and contraction of the mounting band 20 in such a manner that its rotation is restricted in the engaged state in which the hook portions 43f of the rotation restriction member 43 are engaged with the tooth portions 37 of the rear block main body 31, and allows the extension and contraction of the mounting band 20 in such a manner that its rotation is allowed in the cancelled state in which the engagement of the hook portions 43f with the tooth portions 37 is cancelled.

As the details will be described later, in the locked state, during non-rotation of the dial 33, the hook portions 43f of the rotation restriction member 43 and the tooth portions 37 of the rear block main body 31 are put in the engaged state and the rotation of the rotation restriction member 43 is restricted, and accordingly the extension and contraction of the mounting band 20 are restricted. On the other hand, during rotation of the dial 33, in accordance with a rotation of the dial 33, the cancelled state in which the engagement of the hook portions 43f of the rotation restriction member 43 with the tooth portions 37 of the rear block main body 31 is cancelled is achieved, and accordingly the extension and contraction of the mounting band 20 is allowed.

That is, the rotation restriction member 43 is capable of allowing, in the locked state, the extension and contraction of the mounting band 20 according to a rotation of the dial 33 (operation of the operation unit) while restricting the extension and contraction of the mounting band 20 that are not performed in accordance with a rotation of the dial 33 (operation of the operation unit). Typically, in the locked state, the rotation restriction member 43 restricts the rotation of the pinion gear 51b to thereby restrict the extension and contraction of the mounting band 20 during non-rotation of the dial 33 and allows the rotation of the pinion gear 51b to thereby allow the extension and contraction of the mounting band 20 during rotation of the dial 33.

“Dial 33”

Referring to FIGS. 3 to 5 and FIGS. 7 to 8, the dial 33 is rotatable in both the clockwise and counter-clockwise directions around the axis in the front-rear direction.

The dial 33 includes the pair of first groove portions 33a at positions corresponding to the pair of first ribs 43d of the rotation restriction member 43 on its front surface (surface on the side of the rotation restriction member 43). Moreover, the dial 33 includes the pair of second groove portions 33b at positions corresponding to the pair of second ribs 43e of the rotation restriction member 43 on its front surface. The pair of first groove portions 33a are capable of being engaged with the pair of first ribs 43d and the pair of second groove portions 33b are capable of being engaged with the pair of second ribs 43e.

It should be noted that the pair of first ribs 43d in the rotation restriction member 43 and the pair of first groove portions 33a in the dial 33 constitute a cancel mechanism. The cancel mechanism is capable of putting the hook portions 43f of the rotation restriction member 43 in an engaged state with the tooth portions 37 of the rear block main body 31 during non-rotation of the dial 33 and putting the hook portions 43f in a disengaged state with the tooth portions 37 during rotation of the dial 33.

One first groove portion 33a (on the right side of FIG. 7) of the pair of first groove portions 33a is formed so that one end portion of the both end portions in the circumferential direction in the groove (end portion positioned on the counter-clockwise side with respect to the center of the groove) is tilted at a predetermined angle with respect to the radial direction. The tilt of the one end portion in the groove is a clockwise tilt with respect to the radial direction. Accordingly, the one first groove portion 33a is capable of moving one first rib 43d (on the right side of FIG. 7) toward the inner peripheral side in accordance with the clockwise rotation of the dial 33 and cancelling the engaged state of the tooth portions 37 of the rear block main body 31 with one hook portion 43f (on the right side of FIG. 7) of the rotation restriction member 43.

The other first groove portion 33a (on the left side of FIG. 7) of the pair of first groove portions 33a is formed so that one end portion of the both end portions in the circumferential direction in the groove (end portion positioned on the clockwise side with respect to the center of the groove) is tilted at a predetermined angle with respect to the radial direction. The tilt of the one end portion in the groove is a counter-clockwise tilt with respect to the radial direction. Accordingly, the other first groove portion 33a is capable of moving the other first rib 43d (on the left side of FIG. 7) toward the inner peripheral side in accordance with the counter-clockwise rotation of the dial 33 and cancelling the engaged state of the tooth portions 37 of the rear block main body 31 with the other hook portion 43f (on the left side of FIG. 7) of the rotation restriction member 43.

Moreover, the pair of first groove portions 33a lock the pair of first ribs 43d of the rotation restriction member 43 when the dial 33 is rotated by a predetermined angle (e.g., 15 degrees), to thereby be capable of rotating the rotation restriction member 43 integrally with the rotation of the dial 33.

The pair of second groove portions 33b of the dial 33 have a fan shape. The pair of second groove portions 33b lock the pair of second ribs 43e of the rotation restriction member 43 when the dial 33 is rotated by a predetermined angle (e.g., 15 degrees), to thereby be capable of rotating the rotation restriction member 43 integrally with the rotation of the dial 33.

Here, the second ribs 43e of the rotation restriction member 43 and the second groove portions 33b of the dial 33 are provided for support to prevent load from concentrating on the pair of first ribs 43d and damaging the pair of first ribs 43d when the rotation restriction member 43 and the other members rotate in accordance with a rotation of the dial 33.

The dial 33 includes a plurality of gear-like tooth portions 33c at positions on the inner peripheral side in the entire periphery on its rear surface (on the side of the lock levers 44). The plurality of tooth portions 33c is capable of being engaged with protruding portions 44c provided in the lock levers 44.

“First Base 38”

Referring to FIGS. 3 to 4 and FIG. 8, the first base 38 is formed in a table shape having four leg portions. This first base is fixed to the rear block main body 31 via four leg portions in a state in which the pinion gear portion 51, the first biasing spring 41, the clutch 42, the rotation restriction member 43, and the dial 33 are positioned between the first base and the rear block main body 31.

The first base 38 includes, on the rear surface side, a pair of shaft portions 38a capable of rotatably supporting the pair of lock levers 44. Moreover, the first base 38 includes, on the rear surface side, a pair of supporting portions 38b capable of supporting one end sides of the pair of torsion springs 45. Moreover, the first base 38 includes a plurality of openings 38c through which a plurality of pushing protrusions 47b of the cancel button 47 is capable of being inserted.

“Lock Lever 44”

Referring to FIGS. 3 to 5 and FIG. 8, the lock levers 44 are paired at the left and right and has a shape long in one direction. The lock levers 44 have supported portions 44a on the one end sides (the outside in the radial direction) and have stoppers 44b on the other end sides (the inside in the radial direction). The supported portions 44a are rotatably supported by the shaft portions 38a of the first base 38. The stoppers 44b are capable of supporting the clutch 42 from the rear side in the unlocked state and are capable of restricting the rearward movement of the clutch 42 (the movement from the non-working position to the working position).

Moreover, the lock levers 44 include, on their front surfaces, the protruding portions 44c capable of being engaged with the plurality of gear-like tooth portions 33c provided on the rear surface of the dial 33. Moreover, the lock levers 44 include supporting portions 44d capable of supporting the other end portions of the torsion springs 45 at positions near the middle in the longitudinal direction.

The torsion springs 45 have one end portions supported on the supporting portions 38b of the first base 38 and have the other end portions supported by the supporting portions 44d of the lock levers 44, and are capable of clockwisely biasing the lock levers 44 with biasing force thereof.

In a state in which the dial 33 is not yet rotated, the lock levers 44 are capable of maintaining the unlocked state by restricting the rearward movement of the clutch 42 through the stoppers 44b. Moreover, the lock levers 44 are capable of rotating counter-clockwisely in such a manner that the protruding portions 44c engaged with the tooth portions 33c of the dial 33 move outward in the radial direction in accordance with a rotation of the dial 33. At this time, the lock levers 44 cancel the restricted state of the movement of the clutch 42 through the stoppers 44b and allow the rearward movement of the clutch 42 in accordance with the counter-clockwise rotation. Accordingly, the clutch 42 moves from the non-working position to the working position and switches the unlocked state to the locked state.

Moreover, when the cancel button 47 moves the clutch 42 from the working position to the non-working position, the lock levers 44 are capable of clockwisely rotating with the biasing force of the torsion springs 45 and restricting the rearward movement of the clutch 42 through the stoppers 44b again. At this time, the locked state is switched to the unlocked state.

In this embodiment, the tooth portions 33c of the dial 33, the lock levers 44, the torsion springs 45, and the like constitute the switching mechanism. The switching mechanism moves the clutch 42 from the non-working position to the working position in accordance with a rotation of the dial 33.

“Second Base 39”

Referring to FIGS. 3 and 4, the second base 39 is formed in a table shape having four leg portions. This second base is fixed to the first base 38 via the four leg portions in a state in which the lock levers 44 and the torsion springs 45 are positioned between the second base and the first base 38.

The second base 39 includes a housing groove 39a capable of housing the cancel button 47. Moreover, the second base 39 has a plurality of openings 39b through which the plurality of pushing protrusions 47b of the cancel button 47 is capable of being inserted. Moreover, the second base 39 is capable of locking, on the back surface thereof, one end portion of the second biasing spring 46 interposed between the second base 39 and the cancel button 47.

“Second Biasing Spring 46”

The second biasing spring 46 is interposed between the second base 39 and the cancel button 47 and capable of biasing the cancel button 47 toward the rear side. The one end portion of the second biasing spring 46 is locked with the back surface of the second base 39, and the other end portion is locked with a front surface of a button main body 47a in the cancel button 47.

“Cancel Button 47”

The cancel button 47 is movable in the front-rear direction in a state housed in the housing groove 39a of the second base 39. Moreover, the cancel button 47 is biased rearward by the second biasing spring 46.

The cancel button 47 includes the disk-shaped button main body 47a and the plurality of pushing protrusions 47b provided on the button main body 47a. The pushing protrusions 47b are provided to protrude forward at positions on the outer peripheral side on the front surface of the button main body 47a. The pushing protrusions 47b are provided at positions corresponding to the clutch 42 in the radial direction, and capable of moving the clutch 42 from the working position to the non-working position when the cancel button 47 moves forward.

The cancel button 47 is positioned on the rear side with the biasing force of the second biasing spring 46 in a state in which force is not applied to the cancel button 47. On the other hand, when force equal to or greater than the total value of the biasing force of the first biasing spring 41 and the biasing force of the second biasing spring 46 is applied to the cancel button 47 forward, the cancel button 47 moves forward, and when that force is cancelled, the cancel button 47 returns to the original position.

<Description of Operation>

Next, an operation of the mounting mechanism in the HMD 100 when the user wears the HMD 100 will be described.

[Unlocked State]

First of all, it is assumed that the current state is the unlocked state. In the unlocked state, the clutch 42 is located at the non-working position and the clutch 42 and the rotation restriction member 43 are not connected with each other in the direction of rotation. Thus, in the unlocked state, the rotation of the pinion gear portion 51 integral with the clutch 42 in the direction of rotation is allowed. Thus, in the unlocked state, the extension and contraction of the mounting band 20 due to the movement of the rear block 30 relative to the pair of band portions 21 are possible. It should be noted that at this time, due to the racks on the side of the pair of band portions 21 and the pinion gear 51b on the side of the rear block 30, the pair of band portions 21 move equally on the left and right sides with respect to the rear block 30, and therefore the mounting band 20 is capable of extending and contracting equally on the left and right sides.

In the unlocked state, a case where external force has not been applied to the HMD 100 is assumed (e.g., a case where the HMD 100 is placed on a table or the like). In this case, the pair of first spring members 1 pull the rear block 30 and the pair of band portions 21 to cause the mounting band 20 to contract, and therefore the length of the mounting band 20 becomes minimum and the length of the entire HMD 100 becomes minimum.

In this state, it is assumed that the user holds the front block 10 in one hand and holds the rear block 30 in the other hand, and moves the rear block 30 rearward to extend the entire HMD 100. As described above, the second spring members 2 has larger initial load than the first spring members 1. Thus, at the start of extending, only the first spring members 1 having the smaller initial load out of the first spring members 1 and the second spring members 2 move and the second spring members 2 do not move. When the force applied to the second spring members 2 thereafter becomes equal to or larger than the initial load of the second spring member 2 (the clamping force of the entire HMD 100 becomes equal to or larger than the initial load of the second spring member 2: the total tensile force of the pair of first spring members 1 becomes equal to or larger than the initial load of the second spring member 2), the second spring members 2 move and a state in which both the first spring members 1 and the second spring members 2 are moving is provided.

On the other hand, when the user reduces the hand force in the state in which both the first spring members 1 and the second spring members 2 are moving, the entire HMD 100 shrinks with the tensile force of the first spring members 1 and the second spring members 2. Then, when the second spring members 2 completely contract, a state in which only the first spring members 1 are moving is provided, and when the user further reduces the force, the length of the mounting band 20 becomes minimum and the length of the entire HMD 100 becomes minimum.

Specifically, when the user wears the HMD 100, the user holds the front block 10 in one hand and holds the rear block 30 in the other hand, and extends the entire HMD 100 slightly wider than the user's own head. Then, the user puts the HMD 100 on the head and releases the hands from the front block 10 and the rear block 30. At this time, with the tensile force of the first spring members 1 and the second spring members 2, the length of the entire HMD 100 is automatically adjusted in the user's head size.

Hereinafter, the state in which the HMD 100 is mounted on the user's head in the unlocked state will be called temporary mounting for the sake of convenience.

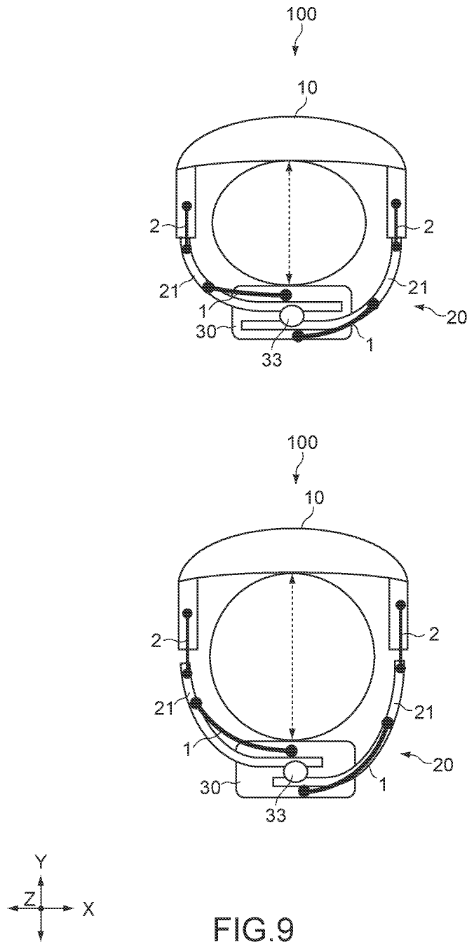

FIG. 9 is a schematic diagram showing a state when the HMD 100 is temporarily mounted on the head. The figure on the upper side of FIG. 9 shows a state when the HMD 100 is temporarily mounted on a user having a short head length (length in the Y-axis direction: see the dotted-line arrow). The figure on the lower side of FIG. 9 shows a state when the HMD 100 is temporarily mounted on a user having a head length (length in the Y-axis direction: see the dotted-line arrow).

The clamping force on the head during the temporary mounting is determined depending on the tensile force caused by the extension of the first spring members 1 and the second spring members 2 during the temporary mounting. That is, as in the figure on the upper side of FIG. 9, in a case where the user has a short head length, the extension of the first spring members 1 and the second spring members 2 is short and the tensile force is small, and therefore the clamping force on the head is relatively small. On the other hand, as in the figure on the lower side of FIG. 9, in a case where the user has a long head length, the extension of the first spring members 1 and the second spring members 2 is long and the tensile force is large, and therefore the clamping force on the head is relatively large.

On the other hand, it is considered desirable that the clamping force on the head during the temporary mounting be as constant as possible irrespective of the head size. It is because suitable clamping force during the temporary mounting is the same for the user having a small head and the user having a large head. The spring constant of the first spring member 1 and the second spring member 2 is set also in consideration of such a point. The details of the spring constant will be described later.

[Locked State]

After the temporary mounting, the user adjusts the HMD 100 so that the display unit 12 of the front block 10 is located at a suitable position in the field of view. Then, the user rotates the dial 33.

When the dial 33 is rotated, the plurality of gear-like tooth portions 33c provided on side of the rear surface of the dial 33 (on the side of the lock levers 44) rotates. Accordingly, the protruding portions 44c of the lock levers 44 that are engaged with the tooth portions 33c of the dial 33 move outward in the radial direction and the lock levers 44 counter-clockwisely rotate. At this time, the lock levers 44 cancel the restricted state of the movement of the clutch 42 through the stoppers 44b and allow the rearward movement of the clutch 42 in accordance with the counter-clockwise rotation.

Accordingly, the clutch 42 moves from the non-working position to the working position with the biasing force of the first biasing spring 41 and the external tooth portions 42b of the clutch 42 and the internal tooth portions 43c of the rotation restriction member 43 are engaged with each other. Accordingly, the unlocked state is switched to the locked state. In the locked state, the rotation restriction member 43 and the clutch 42 are integral with each other in the direction of rotation. Moreover, since the clutch 42 is integral with the pinion gear portion 51 in the direction of rotation, the rotation restriction member 43, the clutch 42, and the pinion gear portion 51 are integral in the direction of rotation.

Moreover, when the dial 33 is rotated, the pair of first groove portions 33a and the pair of second groove portions 33b provided on the side of the front surface of the dial 33 (on the side of the rotation restriction member 43) rotate. It is assumed that the dial 33 is clockwisely rotated. In this case, the one first groove portion 33a (on the right side of FIG. 7) of the pair of first groove portions 33a moves the one first rib 43d (on the right side of FIG. 7) of the rotation restriction member 43 toward the inner peripheral side and moves the one hook portion 43f (on the right side of FIG. 7) of the rotation restriction member 43 toward the inner peripheral side. At this time, the one hook portion 43f of the rotation restriction member 43 is spaced away from the tooth portions 37 of the rear block main body 31 and the engaged state is cancelled.

Moreover, it is assumed that the dial 33 is counter-clockwisely rotated. In this case, the other first groove portion 33a (on the left side of FIG. 7) of the pair of first groove portions 33a moves the other first rib 43d (on the left side of FIG. 7) of the rotation restriction member 43 toward the inner peripheral side and moves the other hook portion 43f (on the left side of FIG. 7) of the rotation restriction member 43 toward the inner peripheral side. At this time, the other hook portion 43f of the rotation restriction member 43 is spaced away from the tooth portions 37 of the rear block main body 31 and the engaged state is cancelled.

When the engaged state of the tooth portions 37 of the rear block main body 31 with the hook portions 43f of the rotation restriction member 43 is cancelled, the pair of first groove portions 33a and the pair of second groove portions 33b of the dial 33 lock the pair of first ribs 43d and the pair of second ribs 43e of the rotation restriction member 43. Accordingly, the rotation restriction member 43 rotates in accordance with a rotation of the dial 33. In the locked state, the rotation restriction member 43 is integral with the clutch 42 and the pinion gear portion 51 in the direction of rotation, and therefore when the dial 33 is rotated, the rotation restriction member 43, the clutch 42, and the pinion gear portion 51 rotate.

Therefore, in the locked state, when the dial 33 is clockwisely rotated, the pinion gear 51b clockwisely rotates and the mounting band 20 contracts. On the other hand, when the dial 33 is counter-clockwisely rotated, the pinion gear 51b counter-clockwisely rotates and the mounting band 20 extends.

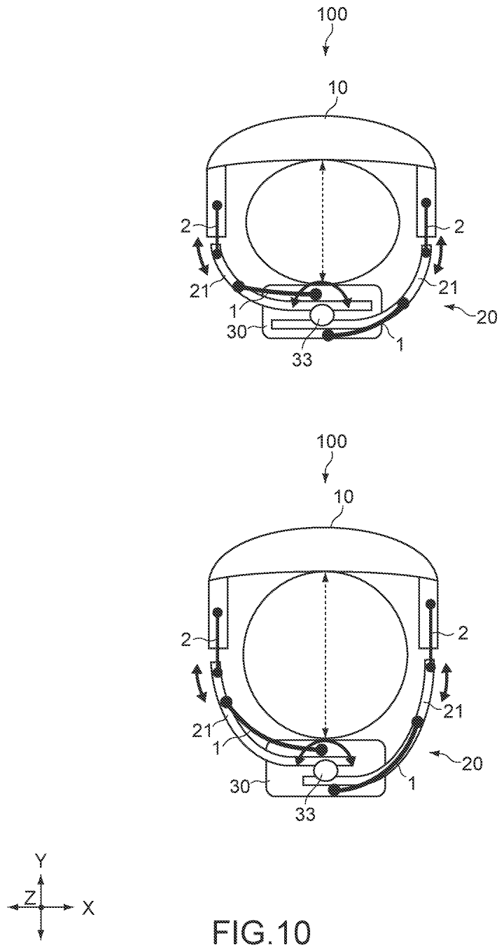

FIG. 10 is a schematic diagram showing a state when the clamping force of the entire HMD 100 on the head is adjusted by rotating the dial 33. The figure on the upper side of FIG. 10 shows an example in a case where the user has a short head length (length in the Y-axis direction: see the dotted-line arrow) and the figure on the lower side of FIG. 10 shows an example in a case where the user has a long head length (length in the Y-axis direction: see the dotted-line arrow).

Here, in the locked state, the extension and contraction of the mounting band 20 that are performed in accordance with a rotation of the dial 33 are allowed. On the other hand, in the locked state, the extension and contraction of the mounting band 20 that are not performed in accordance with a rotation of the dial 33 are restricted. That is, the extension and contraction of the mounting band 20 are restricted with respect to force directly applied to the mounting band 20.

For example, it is assumed that in the locked state, the user holds the front block 10 in one hand and holds the rear block 30 in the other hand, and moves the rear block 30 in the front-rear direction. Moreover, for example, it is assumed that the user holds the pair of band portions 21 in both hands and causes the mounting band 20 to extend and contract. In this case, the hook portions 43f of the rotation restriction member 43 remain in the engaged state with the tooth portions 37 of the rear block main body 31, and therefore the rotation restriction member 43 does not rotate and the clutch 42 and the pinion gear portion 51 integral with the rotation restriction member 43 in the direction of rotation do not rotate. Thus, in this case, the mounting band 20 does not extend and contract.

Moreover, in this embodiment, the first spring members 1 are interposed between the band portions 21 and the rear block 30 and generate force to pull the band portions 21 and the rear block 30 to cause the mounting band 20 to contract. These first spring members 1 do not work once the dial 33 is rotated and the unlocked state is switched to the locked state. It is because the motion in which the first spring members 1 pull the band portions 21 and the rear block 30 to cause the mounting band 20 to contract is the same as the motion in which the first spring members 1 directly apply force to the mounting band 20 to cause the mounting band 20 to contract. That is, in the locked state, the motion in which the first spring members 1 pull the band portions 21 and the rear block 30 with the tensile force to cause the mounting band 20 to contract is restricted by the engagement of the hook portions 43f of the rotation restriction member 43 with the tooth portions 37 of the rear block main body 31.

In this manner, in the locked state, the first spring members 1 do not work, and therefore the clamping force of the entire HMD 100 on the head in the locked state depends on extension and contraction of the second spring members 2.

For example, it is assumed that in the locked state, the user clockwisely rotates the dial 33. At this time, the mounting band 20 contracts in a state in which the relative positions of the front block 10 and the rear block 30 hardly change. Then, the front end sides of the pair of band portions 21 move rearward, and therefore the second spring members 2 extend and the clamping force on the head increases.

In contrast, in the locked state, it is assumed that the user counter-clockwisely rotates the dial 33. At this time, the mounting band 20 extends in a state in which the relative positions of the front block 10 and the rear block 30 hardly change. Then, the front end sides of the pair of band portions 21 move forward, and therefore the second spring members 2 contract and the clamping force on the head decreases.

The user can adjust the clamping force on the head in this manner.

In a case where the user removes the HMD 100 from the head, the user pushes the cancel button 47 forward. Then, due to the forward movement of the cancel button 47, the pushing protrusions 47b of the cancel button 47 move the clutch 42 from the working position to the non-working position. When the clutch 42 is moved to the non-working position, the lock levers 44 clockwisely rotate with the biasing force of the torsion springs 45 and the rearward movement of the clutch 42 is restricted by the stoppers 44b of the lock levers 44. Accordingly, the locked state is switched to the unlocked state.

It should be noted that in a case where the user removes the HMD 100 from the head, the user can also remove it in the locked state from the head without operating the cancel button 47. In this case, since it is in the locked state, the length of the mounting band 20 is maintained. Thus, in this case, there is an advantage that the user does not need to adjust the clamping force on the head by rotating the dial 33 when the user wears the HMD 100 again.

<Spring Constant>

Next, the spring constant of the first spring member 1 and the second spring member 2 will be described. First of all, the spring constant of each of the pair of first spring members 1 is defined as k₁. Moreover, the spring constant of each of the pair of second spring members 2 is defined as k₂.

In the unlocked state, a case where the force on the second spring members 2 is smaller than the initial load of the second spring member 2 (the clamping force of the entire HMD 100 is smaller than the initial load of the second spring member 2: the total tensile force of the pair of first spring members 1 is smaller than the initial load of the second spring member 2) is assumed. In this case, since only the first spring members 1 out of the first spring members 1 and the second spring members 2 move, the spring constant K of the entire HMD 100 is represented by Expression (1) below.

K=2k₁ (1)

In the unlocked state, a case where the force on the second spring members 2 is equal to or larger than the initial load of the second spring member 2 (the clamping force of the entire HMD 100 becomes equal to or larger than the initial load of the second spring member 2: the total tensile force of the pair of first spring members 1 is equal to or larger than the initial load of the second spring member 2) is assumed. In this case, since both the first spring members 1 and the second spring members 2 move and the first spring members 1 and the second spring members 2 are connected in series, the spring constant K of the entire HMD 100 is represented by Expression (2) below.

K=2k₁k₂/(k₁+k₂) (2)

In the locked state, since the first spring members 1 do not work, the spring constant K′ of the entire HMD 100 in the locked state is represented by Expression (3) below.

K=2k₂ (3)

Moreover, provided that the relationship between k₁ and k₂ is nk₁=k₂, Expressions (1) to (3) above are represented by Expressions (4) to (6) below in order.

K=2k₁ (4)

K=2nk₁/(n+1) (5)

K′=2nk₁ (6)

Therefore, when n is a real number larger than 1, K<K′. That is, in a case where the spring constant of the second spring member 2 is set to be higher than the spring constant of the first spring member 1, the spring constant K′ of the entire HMD 100 in the locked state is higher than the spring constant K of the entire HMD 100 in the unlocked state.

That is, in this embodiment, the spring constant K of the entire HMD 100 when the HMD 100 is mounted in the unlocked state can be set to be relatively small and the spring constant K′ of the entire HMD 100 when the clamping force is adjusted in the locked state can be set to be relatively large.

[Design Example of Suitable Spring Constant]

Next, a setting example of a suitable spring constant will be described. What is the most important for setting the spring constant to a suitable value is how much range is set as the range of the clamping force when the HMD 100 is finally mounted on the head should. Although it cannot be said sweepingly because the suitable range of the clamping force depends on the total weight of the HMD 100, it is assumed that the total weight is in a predetermined range in the example here.

First of all, the spring constant k₁ of the first spring member 1 was set to 0.059 N/mm and the spring constant k₂ of the second spring member 2 was set to 0.15 N/mm. Moreover, the initial load of the second spring member 2 was set to 6.5 N and the upper-limit load was set to 12.5 N. It should be noted that in the example here, the spring constant k₂ of the second spring member 2 is about 2.5 times as high as the spring constant k₁ of the first spring member 1.

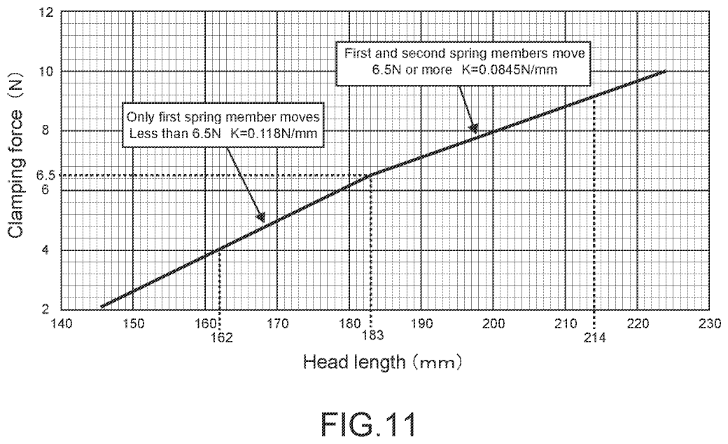

First of all, the unlocked state will be described. FIG. 11 is a diagram showing a relationship between the clamping force of the entire HMD 100 in the unlocked state and the head length (length in the Y-axis direction: see the dotted-line arrow in FIGS. 9 and 10).

First of all, a case where in the unlocked state, the force on the second spring members 2 is smaller than 6.5N that is the initial load of the second spring member 2 (the clamping force of the entire HMD 100 is smaller than 6.5N: the total tensile force of the pair of first spring members 1 is smaller than 6.5N that is the initial load of the second spring member 2) is assumed. In this case, since only the first spring members 1 work, the spring constant K of the entire HMD 100 is K=0.118 N/mm in accordance with Expression (1) above.

Moreover, a case where in the unlocked state, the force on the second spring members 2 is equal to or larger than 6.5N that is the initial load of the second spring member 2 (the clamping force of the entire HMD 100 is equal to or larger than 6.5N: the total tensile force of the pair of first spring members 1 is equal to or larger than 6.5N that is the initial load of the second spring member 2) is assumed. In this case, since both the first spring members 1 and the second spring members 2 work, the spring constant K of the entire HMD 100 is K=0.0845 N/mm in accordance with Expression (2) above.

That is, in a case where both the first spring members 1 and the second spring members 2 work, the spring constant K of the entire HMD 100 is slightly lower as compared with a case where only the first spring members 1 work.

As shown in FIG. 11, here, it is assumed that the wearable range is 162 mm to 214 mm as the user's head length (length in the Y-axis direction). In a case where a user having a head length of 162 mm, which is assumed as the smallest head length in the wearable range, temporarily mounts the HMD 100, the clamping force of the entire HMD 100 is 4N. On the other hand, in a case where a user having a head length of 214 mm, which is assumed as the largest head length in the wearable range, temporarily mounts the HMD 100, the clamping force of the entire HMD 100 is 9.2 N.

That is, as to the clamping force of the entire HMD 100 on the head during the temporary mounting, a difference of 5.2 N is generated with a head length difference of 52 mm. As described above, it is desirable to set the clamping force of the entire HMD 100 on the head during the temporary mounting to be as constant as possible irrespective of the head size. In order to reduce this difference of the clamping force based on the head length difference, it is possible to reduce the spring constant of the first spring member 1. On the other hand, in general, reducing the spring constant of the first spring member 1 reduces the clamping force of the entire HMD 100, and it is necessary to make the first spring members 1 longer in order to keep the clamping force of the entire HMD 100, and therefore it is disadvantageous in view of the space.

Since it is generally considered that it is unlikely that the user in the temporary mounting state moves the head hard and the HMD 100 is displaced from the head, it is sufficient that the spring constant of the first spring member 1 is set in a realistic range in consideration of the total weight of the HMD 100.

Next, the locked state will be described. In the locked state, since the first spring members 1 do not work, the spring constant K′ of the entire HMD 100 in the locked state is K′=0.3 N/m in accordance with Expression (3) above. That is, when the dial 33 is rotated and the unlocked state is switched to the locked state, the spring constant of the entire HMD 100 increases to 0.3 N/m from 0.118 N/mm or 0.0845 N/mm. That is, the spring constant of the entire HMD 100 becomes about 2.5 times or about 3.5 times.

As described above, the initial load of the second spring member 2 is 6.5 N and the upper-limit load is 12.5 N. Thus, since the spring constant is 0.3 N/mm with respect to a load difference of 6 N, in the locked state, rear end portions of the second spring members 2 are movable by 20 mm in the front-rear direction with respect to the front block 10 and the clamping force of the entire HMD 100 changes by 6 N with this movement by 20 mm.

For example, in a case where a pinion gear 51b (module 1) having 20 teeth is used, the pitch circle diameter is Φ20, and therefore one rotation is 62.8 mm. Thus, a necessary angle of the dial 33 for changing the clamping force of the entire HMD 100 by 6 N is 115 degrees (360 degrees×20 mm/62.8 mm). In other words, when the dial 33 is rotated by 10 degrees in a state in which the HMD 100 is mounted on the head, the clamping force of the entire HMD 100 changes by about 0.5 N.

In the example here, the initial load of the second spring member 2 is set to 6.5 N. It is because the range of the clamping force of the entire HMD 100 that is adjusted in the locked state is set to be equal to or larger than 6.5 N. Since a suitable value of this initial load of the second spring member 2 changes depending on the total weight of the HMD 100, this value is set as appropriate in consideration of the total weight of the HMD 100.

<Actions, Etc.>

Next, actions, etc. in this embodiment will be described. In the description here, first of all, the technology described in Patent Literature 1 above will be described as a comparative example related to this embodiment.

This HMD described in Patent Literature 1 includes a main body on a front side of the head that incorporates the display and an annular mounting band that is fixed to the main body and extends from a rear side of the main body. The mounting band includes a front supporting portion connected to an upper portion of the main body, a pair of left and right extension portions extending rearward from the front supporting portion, and a movable portion on a rear side of the head that is movable relative to the pair of extension portions in the front-rear direction.

The mounting band is capable of extending and contracting due to the movement of the movable portion with respect to the pair of extension portions in the front-rear direction. The movable portion is provided with the lock mechanism 40 that switches between the unlocked state and the locked state. In the unlocked state, the movement of the movable portion (extension and contraction of the mounting band) in the front-rear direction is allowed, and in the locked state, the movement of the movable portion (extension of the mounting band) in the rear direction is restricted.

The mounting band is provided with a pair of left and right elastic members along the pair of extension portions. One end side of this elastic member is fixed to the front supporting portion of the mounting band and the other end side is fixed to the movable portion. The elastic member pulls the movable portion forward with its tensile force to thereby cause the mounting band to contract.

The movable portion is provided with the dial. The lock mechanism switches the unlocked state to the locked state in accordance with a rotation of the dial. The dial is provided with a stopper. This stopper allows the clockwise rotation of the dial (contraction of the mounting band) and restricts the counter-clockwise rotation of the dial (extension of the mounting band). In the locked state, the counter-clockwise rotation of the dial is restricted by the stopper, and the extension of the mounting band is restricted.

In the HMD according to the comparative example, there is a problem in that it is difficult to adjust the clamping force of the entire HMD on the head because of the use of one kind of elastic member. In particular, in the comparative example, there is a problem in that the clamping force rapidly increases when the clamping force of the entire HMD is adjusted by rotating the dial because the pair of extension portions are fixed to the main body on the front side of the head.

In this regard, in the HMD 100 according to this embodiment, two kinds of elastic members, the pair of first spring members 1 and the pair of second spring members 2, are used as the elastic member, and therefore the adjustment of the clamping force of the entire HMD 100 on the head can be facilitated.

In particular, in this embodiment, as in the comparative example, the pair of band portions 21 are not fixed to the front block 10, and the pair of second spring members 2 are interposed between the front block 10 and the pair of band portions 21. In this embodiment, since this second elastic material extends and contracts when the clamping force of the entire HMD 100 is adjusted by rotating the dial 33, the clamping force can be prevented from rapidly increasing as in the comparative example.

Moreover, in this embodiment, because of a combination of the two kinds of elastic members, the pair of first spring members 1 and the pair of second spring members 2, and the lock mechanism 40 that switches between the unlocked state and the locked state, the clamping force of the entire HMD 100 can be changed in the unlocked state and the locked state.

In particular, in this embodiment, by stopping the motion of the pair of first spring members 1 through the lock mechanism 40 (the rotation restriction member 43) in the locked state, the clamping force of the entire HMD 100 can be changed in the unlocked state and the locked state.

Moreover, in this embodiment, the spring constant of the first spring member 1 and the spring constant of the second spring member 2 are different, and in particular, the spring constant of the second spring member 2 is set to take a value larger than that of the spring constant of the first spring member 1. Accordingly, it is possible to reduce the spring constant of the entire HMD 100 when the HMD 100 is mounted in the unlocked state and to increase the spring constant of the entire HMD 100 when the clamping force of the entire HMD 100 is adjusted by rotating the dial 33 in the locked state. It should be noted that as described above, typically, the spring constant of the second spring member 2 is set to be twice or more as large as the spring constant of the first spring member 1.

Here, with the HMD according to the comparative example, the extension of the mounting band is restricted by restricting the counter-clockwise rotation of the dial through the stopper in the locked state. That is, in the comparative example, the clamping force of the HMD cannot be reduced by counter-clockwisely rotating the dial in the locked state. Therefore, when the user excessively rotates the dial and feels that the clamping force is too strong, the user needs to adjust the clamping force of the HMD by rotating the dial again after switching the locked state to the unlocked state through the push button.

In this regard, in this embodiment, the rotation of the dial 33 itself is not restricted. On the other hand, in the locked state, the rotation restriction member 43 is restricted in both the clockwise and counter-clockwise directions. However, this restriction is restriction for external force not caused by the rotation of the dial 33, and this restriction is cancelled by the cancel mechanism (the pair of first groove portions 33a of the dial 33, the pair of first ribs 43d of the rotation restriction member 43) in accordance with a rotation of the dial 33.

Specifically, in this embodiment, in a case where the dial 33 is rotated in both the clockwise and counter-clockwise directions, the rotation restriction member 43 also rotates in the both directions and the clutch 42 and the pinion gear portion 51 also rotate in the both directions integrally with this. Thus, in this embodiment, it is possible to cause the mounting band 20 to both extend and contract in accordance with a rotation of the dial 33. Thus, in this embodiment, when the user excessively rotates the dial 33 and feels that the clamping force is too strong, the user does not need to perform troublesome operations as in the comparative example and only needs to simply rotate the dial 33 counter-clockwisely.

Moreover, with the HMD according to the comparative example, the extension of the mounting band is restricted while the contraction of the mounting band is not restricted in the locked state. Moreover, in the locked state, the elastic member moves to cause the mounting band to contract with its tensile force. Therefore, when the user removes the HMD from the head while it remains in the locked state, the HMD shrinks to the minimum position (shrinks similarly also in the unlocked state) due to the elastic member. Therefore, even when the same user mounts that HMD, the user needs to return the locked state to the unlocked state with the push button and then mount the HMD on the head and adjust the clamping force of the HMD by rotating the dial again.

On the other hand, in this embodiment, in the locked state, with respect to external force caused not by the rotation of the dial 33, not only the extension of the mounting band 20 but also the contraction of the mounting band 20 are restricted by the rotation restriction member 43. Thus, in this embodiment, even when the user removes the HMD 100 from the head while it remains in the locked state, the HMD 100 does not shrink to the minimum position due to the first spring members 1. Thus, since the HMD 100 is already adjusted to clamping force optimal to the user when the same user mounts that HMD 100 again, the user does not need to adjust the clamping force of the HMD 100 by rotating the dial 33 again.

Moreover, when the user mounts/removes the HMD 100 while it remains in the locked state, the second spring members 2 extend and contract, and therefore the mounting/removal of the HMD 100 is easy.

### Second Embodiment

Next, a second embodiment of the present technology will be described. In the descriptions of the second embodiment and embodiments following the second embodiment, members having configurations and functions identical to those of the first embodiment will be denoted by identical reference signs and the descriptions will be simplified or omitted.

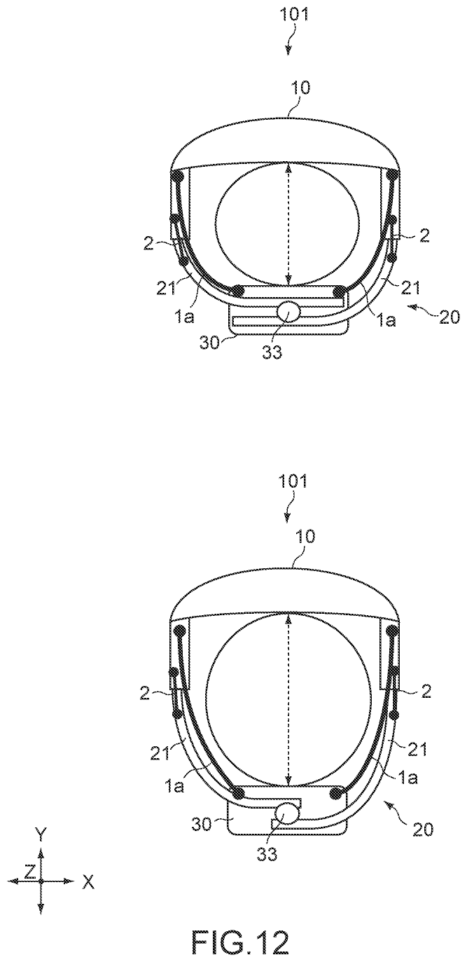

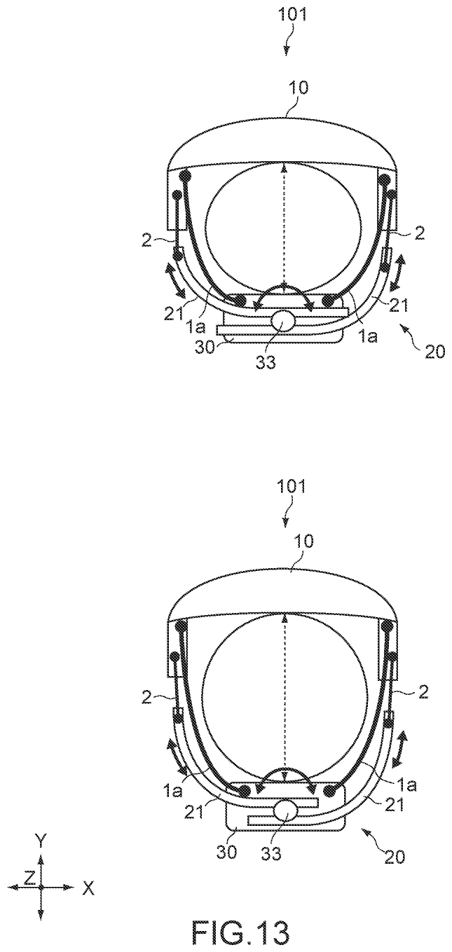

FIG. 12 is a schematic diagram showing a state when an HMD 101 according to the second embodiment is temporarily mounted on the head in the unlocked state. FIG. 13 is a schematic diagram showing a state when the clamping force of the entire HMD 101 on the head is adjusted by rotating the dial 33 in the locked state. In FIG. 12 or 13, an example in a case where the user has a short head length (length in the Y-axis direction: see the broken-line arrow) is shown on the upper side and an example in a case where the user has a long head length (length in the Y-axis direction: see the broken-line arrow) is shown on the lower side.

Here, in the first embodiment, the pair of first spring members 1 are interposed between the pair of band portions 21 and the rear block 30. In this regard, in the second embodiment, the pair of first spring members 1a are interposed between the front block 10 and the rear block 30. Other points are basically similar to those of the first embodiment.

The pair of first spring members 1a have one end portions fixed to the pair of fixing portions 14 of the front block 10 and the other end portions fixed to the rear block 30. The pair of first spring members 1a have tensile force to cause the mounting band 20 to contract as in the first embodiment.

In the second embodiment, in the unlocked state, the pair of band portions 21 are capable of extending and contracting, and there are no elements that produce external force to act on the pair of second spring members 2. Thus, in the unlocked state, the pair of second spring members 2 do not work.

Therefore, in the unlocked state, only the pair of first spring members 1a move and the clamping force of the entire HMD 101 on the head depends on extension and contraction of the pair of first spring members 1a. Here, the spring constant K of the entire HMD 101 in the unlocked state is represented by Expression (4) below using the spring constant k₁ in the first spring members 1a.

K=2k₁ (4)

As shown in FIG. 13, it is assumed that the dial 33 is rotated from the temporary mounting state and the unlocked state is switched to the locked state. In this case, the pair of second spring members 2, which have not worked in the unlocked state, work. That is, when the dial 33 is rotated in the locked state, the front end sides of the pair of band portions 21 move in the front-rear direction while the distance between the front block 10 and the rear block 30 hardly changes, and therefore the pair of second spring members 2 extend and contract. Thus, the clamping force of the entire HMD 101 changes in accordance with extension and contraction of the pair of second spring members 2.

Moreover, in the first embodiment, although the pair of first spring members 1 have not worked in the locked state, the first spring members 1a work also in the locked state in this second embodiment. That is, the pair of first spring members 1a pull the rear block 30 toward the front block 10 with certain tensile force also in the locked state. It should be noted that in the locked state, the distance between the front block 10 and the rear block 30 hardly changes, and therefore the tensile force itself of the pair of first spring members 1a hardly changes.

As described above, the clamping force F of the entire HMD 101 in the locked state is represented in accordance with Expression (5) below using the clamping force f₁ of the first spring members 1a, the spring constant k₂ of the second spring member 2, and the extension x of the second spring members 2.

F=2f₁+2k₂x (5)

Therefore, the spring constant K′ in the locked state in the second embodiment is 2k₂ that is the same as that in the first embodiment. That is, in the locked state, how much the clamping force changes when the dial 33 is rotated is the same as that in the first embodiment.

However, in the second embodiment, the pair of first spring members 1a work also in the locked state and the element 2f1 acts on the clamping force F of the entire HMD 101. Therefore, there is an advantage that the clamping force F of the entire HMD 101 in the locked state increases more easily than in the first embodiment.

### Third Embodiment

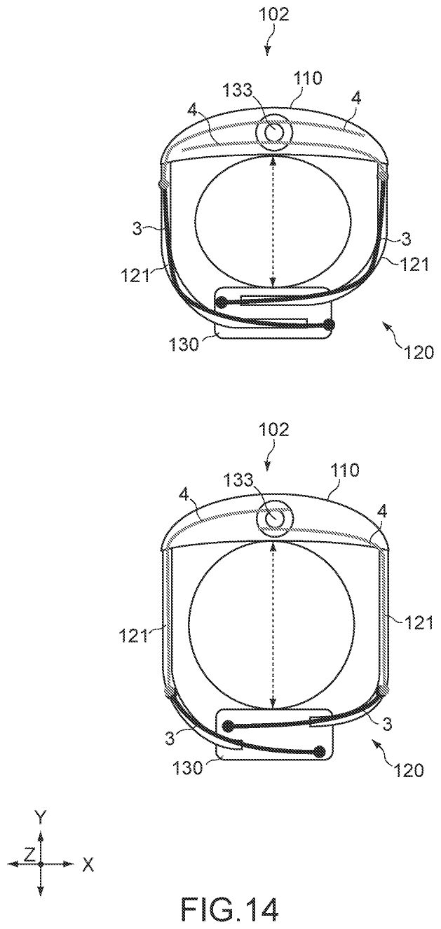

Next, a third embodiment of the present technology will be described. FIG. 14 is a schematic diagram showing a state when the clamping force of the entire HMD 102 on the head is adjusted in an HMD 102 according to the third embodiment. In FIG. 14, an example in a case where the user has a short head length (length in the Y-axis direction: see the broken-line arrow) is shown on the upper side and an example in a case where the user has a long head length (length in the Y-axis direction: see the broken-line arrow) is shown on the lower side.

The HMD 102 according to the third embodiment includes a front block 110 that is mounted on a front side of a head and a mounting band 120 configured to surround the sides of the head and the back of the head. The mounting band 120 includes a pair of left and right band portions 121 that are mounted on left and right sides of the head and a rear block 130 that is mounted on a rear side of the head and movable relative to a pair of band portions 121. This mounting band 120 is capable of extending and contracting due to the movement of the rear block 130 relative to the pair of band portions 121.

Moreover, the HMD 102 includes a dial 133 provided in the front block 110 and a pair of left and right link members 4 movable along the pair of band portions 121 in accordance with the operation of the dial 133. Moreover, the HMD 102 includes a pair of left and right spring members 3 provided between the pair of link members 4 and the rear block 30.

In the HMD 102 according to the third embodiment, the pair of band portions 121 are fixed to the front block 110 unlike each of the above-mentioned embodiments. Moreover, in this HMD 102, the dial 133 is provided not in the rear block 130 but in the front block 110. Moreover, in this HMD 102, one kind of spring member is used and the pair of link members 4 are provided.

The dial 133 is provided with a pinion gear that rotates in accordance with a rotation of the dial 133. Moreover, racks that are engaged with a pinion gear are provided in certain regions on front end sides of the pair of link members 4. Rear end sides of the pair of link members 4 are fixed to front end sides of the pair of spring members. The pair of link members 4 are movable equally on the left and right sides along the pair of band portions 121 in accordance with a rotation of the dial 133.

The pair of spring members 3 are capable of extending and contracting along the pair of band portions 121. Front end sides of the pair of spring members 3 are fixed to the rear end sides of the pair of link members 4 and rear end sides of the pair of spring members are fixed to the rear block 130.

In this HMD 102, when the dial 133 is rotated, rear ends of the pair of link members 4 move in the front-rear direction along the pair of band portions 121 in accordance with this rotation. Accordingly, front ends of the pair of spring members 3 move in the front-rear direction along the pair of band portions 121, and therefore the pair of spring members 3 extend and contract. The clamping force of the entire HMD 102 is adjusted by extension and contraction of the pair of spring members 3.

Here, as described above, a case where the wearable range is 162 mm to 214 mm as the user's head length (length in the Y-axis direction) is assumed. In this case, for adjustment of load of 6 N, in a case where the spring constant of the spring member 3 is 0.1 N/mm, the spring member 3 needs to extend by 60 mm. In this case, alignment by about 112 mm through the pair of link members 4 is necessary.

If the pinion gear having a pitch circle diameter of Φ20 is used, it is equivalent to two rotations of the dial 133. In this case, there is a fear that the adjustment of the clamping force of the entire HMD 102 becomes troublesome, and therefore for example, a speed up gear or the like may be used as a mechanism for moving the pair of link members 4.

Here, for example, the clamping force of the entire HMD 102 extended to 214 mm in a state in which the clamping force of the entire HMD 102 is adjusted to 12.5 N with a head length of 162 mm is 17.4 N. In this case, it is necessary to check that the used maximum clamping force will not exceed allowable load of the spring member.

It should be noted that in the third embodiment, the rotation restriction member 43 may be provided so that the link members 4 do not move even when force is directly applied to the link members 4. On the other hand, in the third embodiment, the switching mechanism that switches between the unlock and locked states can be omitted and the mechanism can be simplified. The HMD 102 according to the third embodiment is effective especially in a case where the range of the head length assumed is small or in a case where the adjustment range of the clamping force of the entire HMD 102 is small.

### Fourth Embodiment

Next, a fourth embodiment of the present technology will be described. In the fourth embodiment and an embodiment following the fourth embodiment, a mechanism for automatically preventing mounting displacement of the HMD with respect to the head will be described.

In the AR display-type or VR display-type HMD, when the mounting position is displaced with respect to the head, a phenomenon where part of the vision through the display unit is lost may occur. In particular, in a case of the AR display-type HMD, even with relatively small displacement of the mounting position, it can cause so-called misalignment in which a deviation is generated between a virtual image and a real image. Thus, the problem of the mounting displacement in the AR display-type HMD is more serious than the mounting displacement in the VR display-type HMD.

In order to cope with such a problem, a mechanism for automatically preventing a mounting displacement of the HMD with respect to the head is provided in the HMD in the fourth embodiment and the embodiment following the fourth embodiment.

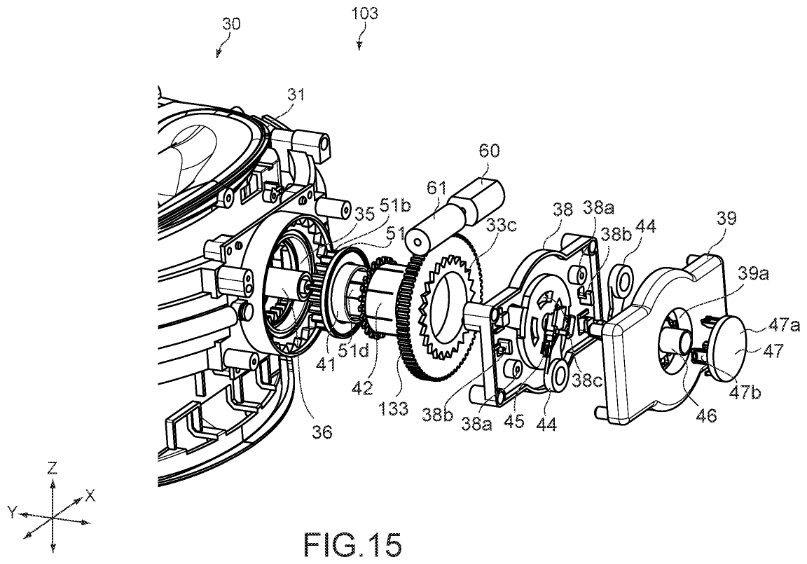

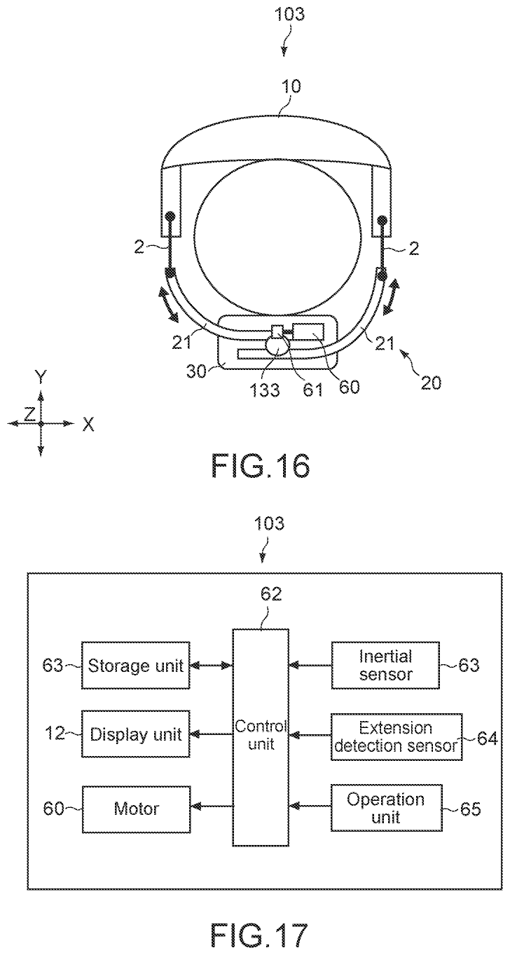

FIG. 15 is an exploded perspective view as the respective parts in the rear portion of the rear block main body 31 are viewed from the rear side in an HMD 103 according to the fourth embodiment. FIG. 16 is a schematic diagram as the HMD 103 is viewed from above. It should be noted that although the pair of first spring members 1 are omitted in FIG. 16, the pair of first spring members 1 are provided between the pair of band portions 21 and the rear block 30 or provided between the front block 10 and the rear block 30 as in the first or second embodiment.

As shown in FIGS. 15 and 16, the HMD 103 according to the fourth embodiment includes a motor 60 (drive unit) that generates driving force to cause the mounting band 20 to extend and contract and a drive shaft of the motor 60 is provided with a worm drive 61. Moreover, the HMD 103 includes a worm wheel 133 that is engaged with the worm drive 61. This worm wheel 133 is capable of causing the mounting band 20 to extend and contract by being rotated by the worm drive 61. That is, in the HMD 103 according to the fourth embodiment, the dial 33 in the first or second embodiment is the worm wheel 133.

Moreover, in the HMD 103 according to the fourth embodiment, the rotation restriction member 43 is not provided unlike the first and second embodiments. In this HMD 103, when the clutch 42 moves from the non-working position to the working position, the clutch 42 is capable of being engaged with the worm wheel 133. Therefore, in the locked state, the worm wheel 133, the clutch 42, and the pinion gear portion 51 integrally rotate in the direction of rotation.

It should be noted that other points in the mechanical configuration of the mounting mechanism in the HMD 103 according to the fourth embodiment are basically similar to those of the above-mentioned first or second embodiment.

Here, in the fourth embodiment, the speed reduction ratio of the worm drive 61 is set to 1/40 or less. That is, in the fourth embodiment, setting the speed reduction ratio of the worm drive 61 to be 1/40 or less provides a self-lock function, which prevents the motor 60 from reversely rotating with reaction torque from the pinion gear 51b. Due to the presence of this self-lock function, the rotation restriction member 43 is unnecessary in the fourth embodiment.

On the other hand, a simple flat-tooth structure may be used instead of the worm drive 61 and the worm wheel 133. In this case, the rotation restriction member 43 may be used because the self-lock function is not provided. In this case, the speed reduction ratio can be freely selected without the need to set the speed reduction ratio to be 1/40 or less.

FIG. 17 is a block diagram showing an electrical configuration of the HMD 103. As shown in FIG. 17, the HMD 103 includes a control unit 62, a storage unit 63, a display unit 12, a motor 60, an inertial sensor 63, an extension detection sensor 64, and an operation unit 65.

The display unit 12 is capable of performing VR display or AR display under the control of the control unit 62. The motor 60 is capable of causing the mounting band 20 to extend and contract by rotating the worm wheel 133 clockwisely and counter-clockwisely.

The inertial sensor 63 is configured to be capable of acquiring inertial information of at least a gravity direction (Z-axis direction). An acceleration sensor that detects information (inertial information) of the acceleration in the gravity direction is typically used as the inertial sensor 63. It should be noted that the acceleration sensor may be replaced by another sensor such as a speed sensor. In this case, for example, speed information (inertial information) detected by the speed sensor may be differentiated and used as the acceleration information.

In the example here, although a case where a detection axis of the inertial sensor 63 is one axis of the gravity direction will be described, the detection axis of the inertial sensor 63 may be two axes or three axes including the front-rear direction and the left-right direction. Although the inertial sensor 63 is disposed in the front block 10, the rear block 30, or the like for example, the inertial sensor 63 may be disposed in any portion of the HMD 103 as long as it can acquire at least the inertial information of the gravity direction.

The extension detection sensor 64 is a sensor for detecting how much the second spring members 2 have extended at the current time and how much force the clamping force of the entire HMD 103 is at the current time. The extension detection sensor 64 is, for example, various sensors such as an optical sensor and this extension detection sensor 64 is, for example, fixed to one coupling portion 15 of the pair of coupling portions 15 in the front block 10. Moreover, one second spring member 2 of the pair of second spring members 2 is provided with a mark such as a protrusion that is detected by the extension detection sensor 64.

When the mark in the second spring members 2 is located at a detection position, the extension detection sensor 64 detects and outputs it to the control unit 62. Using the clamping force of the HMD 103 (prestored in the storage unit 63) when the mark is located at the detection position as the basis, the control unit 62 calculates clamping force of the entire HMD 103 at the current time on the basis of a rotational angle of the motor 60 from there and the spring constant of the second spring member 2.

The operation unit 65 is a portion for the user to drive the motor 60 to adjust the clamping force of the entire HMD 103. This operation unit 65 is, for example, a push button-type or proximity-type operation unit and is capable of both decreasing and reducing the clamping force. Although the operation unit 65 is, for example, disposed in the front block 10, the rear block 30, or the like, the operation unit 65 may be disposed in any portion of the HMD 103 as long as the user easily operate it.

The control unit 62 performs various arithmetic operations on the basis of various programs stored in the storage unit 63 and comprehensively controls the respective parts of the HMD 103. In particular, in the fourth embodiment, the control unit 62 controls the motor 60 on the basis of information regarding the acceleration in the gravity direction and performs processing of causing the mounting band 20 to extend and contract.

The control unit 62 is realized by hardware or a combination of hardware and software. The hardware is configured as a part of the control unit 62 or the entire control unit 62. Examples of this hardware can include a central processing unit (CPU), a graphics processing unit (GPU), a digital signal processor (DSP), a field programmable gate array (FPGA), an application specific integrated circuit (ASIC), and a combination of two or more of them.

The storage unit 63 includes a nonvolatile memory in which various programs and various types of data required for the processing of the control unit 62 are stored and a volatile memory used as a work area of the control unit 62. It should be noted that the various programs may be read from a portable recording medium such as an optical disc and a semiconductor memory or may be downloaded from a server device in a network.

<Description of Operation>

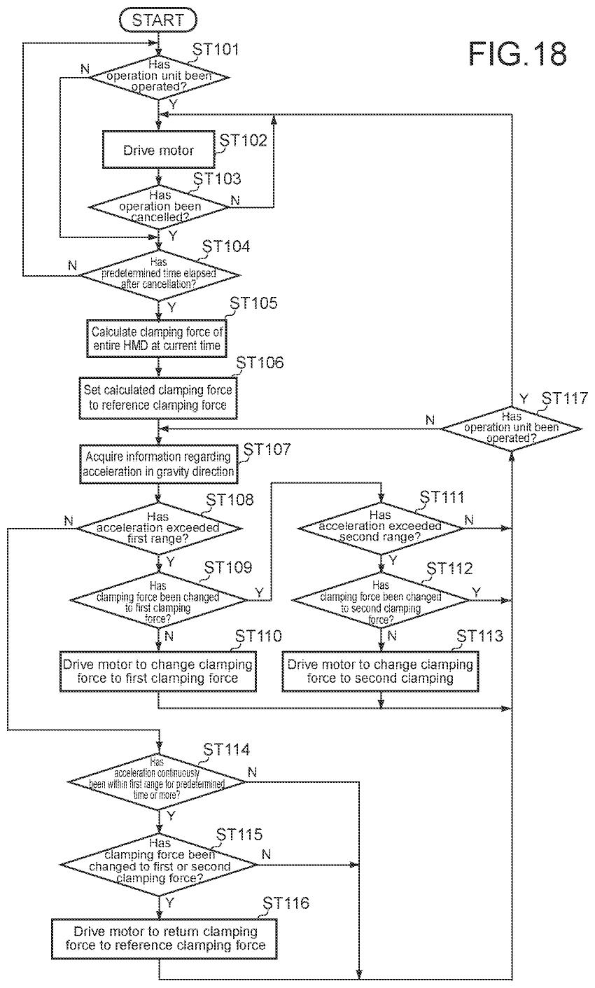

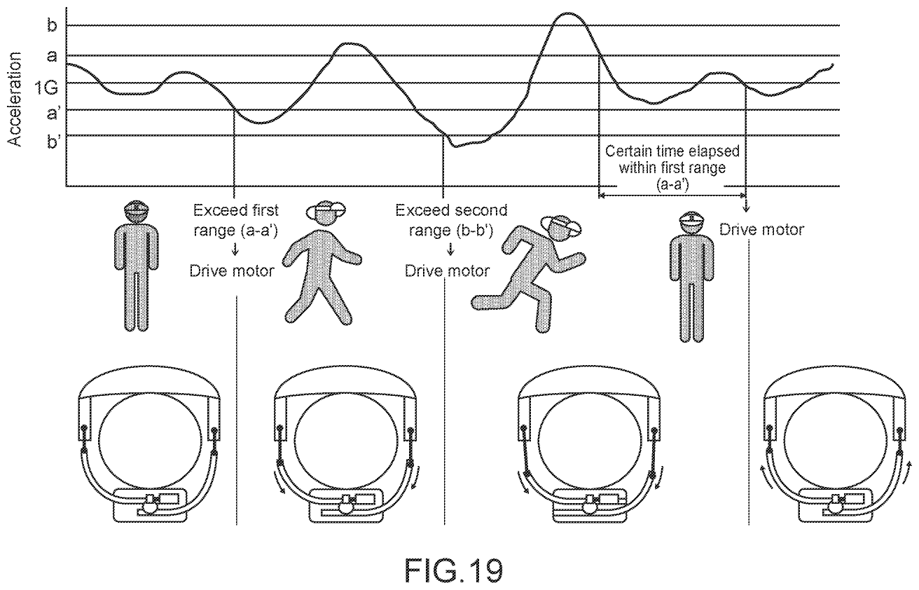

Next, processing in the control unit 62 of the HMD 103 will be described. FIG. 18 is a flowchart showing the processing of the control unit 62. FIG. 19 is a diagram showing an example in a case where the clamping force of the entire HMD 103 has been automatically adjusted in accordance with the acceleration in the gravity direction.

First of all, the user temporarily mounts the HMD 103. Operations until the HMD 103 is temporarily mounted are similar to those of the first or second embodiment. After the temporary mounting, the user operates the operation unit 65 in order to adjust the clamping force of the entire HMD 103.

First of all, the control unit 62 determines whether the operation unit 65 has been operated (Step 101). In a case where the operation unit 65 has been operated (YES in Step 101), the control unit 62 drives the motor 60 to rotate the worm wheel 133 (Step 102).

When the driving of the motor 60 is started and is started and the rotation of the worm drive 61 is started, the unlocked state is switched to the locked state. When the worm wheel 133 rotates, the clutch 42 and the pinion gear portion 51 rotate integrally with it, and the mounting band 20 extends and contracts accordingly. At this time, the pair of second spring members 2 extend and contract, and the clamping force of the entire HMD 103 changes.

After the control unit 62 drives the motor 60, the control unit 62 determines whether the operation of the operation unit 65 has been cancelled (Step 103). In a case where the operation of the operation unit 65 has not been cancelled (NO in Step 103), the control unit 62 returns to Step 102 and continuously drives the motor 60.

The user cancels the operation of the operation unit 65 at the time at which the clamping force of the entire HMD 103 becomes suitable clamping force. In a case where the operation unit 65 has been cancelled (YES in Step 103), the control unit 62 proceeds to next Step 104. It should be noted that also in a case where the operation unit 65 has not been operated (NO in Step 101) in Step 101, the control unit 62 proceeds to Step 104.

In Step 104, the control unit 62 determines whether a predetermined time (e.g., approximately 3 seconds to 5 seconds) has elapsed with the operation unit 65 not operated after the operation of the operation unit 65 has been cancelled. In a case where the predetermined time has not elapsed (NO in Step 104), the control unit 62 returns to Step 101 and determines whether the operation unit 65 has been operated again.

In a case where the predetermined time has elapsed with the operation unit 65 not operated after the operation of the operation unit 65 has been cancelled (YES in Step 104), the control unit 62 calculates clamping force of the entire HMD 103 at the current time (Step 105). The clamping force of the entire HMD 103 at the current time is, as described above, calculated on the basis of the rotational angle of the motor 60 from there and the spring constant of the second spring member 2, using the clamping force of the HMD 103 when the mark of the second spring member 2 is located at the detection position of the extension detection sensor 64 as the basis.

When calculating the clamping force of the entire HMD 103 at the current time, then the control unit 62 sets the calculated clamping force to the reference clamping force (Step 106). This reference clamping force is a value that is the basis when the clamping force of the entire HMD 103 is adjusted on the basis of the information regarding the acceleration in the gravity direction.

Next, the control unit 62 acquires, from the inertial sensor 63, the information regarding the acceleration in the gravity direction at the current time (Step 107). Next, the control unit 62 determines whether the acceleration has exceeded a first range centered at the gravitational acceleration 1G (Step 108). For example, as shown in FIG. 19, the first range is an a-a′ range centered at the gravitational acceleration 1G.

This first range (values of a and a′) is a default value, considering the total weight of the HMD 103. For example, in a case where the total weight of the HMD 103 is relatively large, the first range is set to be a relatively narrow range, and in a case where the total weight of the HMD 103 is relatively small, the first range is set to be a relatively wide range. It should be noted that the same applies to a second range to be described later.

Moreover, the first range (values of a and a′) may be changed by the control unit 62 in accordance with the reference clamping force. Here, it is assumed that the clamping force of the entire HMD 103 (reference clamping force) is slightly different for each user. For example, in a case of a user who likes mounting the HMD 103 tightly, the reference clamping force is relatively strong. In contrast, in a case of a user who likes mounting the HMD 103 loosely, the reference clamping force is relatively weak. In this case, in a case where the reference clamping force is relatively strong, the first range is set to be a relatively wide range, and in a case where the reference clamping force is relatively weak, the first range is set to be a relatively narrow range. It should be noted that the same applies to the second range to be described later.

In a case where the acceleration in the gravity direction has exceeded the first range (YES in Step 108), the control unit 62 determines whether the clamping force of the entire HMD 103 has not yet been changed to the first clamping force (Step 109). In a case where the clamping force of the entire HMD 103 has not yet been changed to the first clamping force (NO in Step 109), the control unit 62 drives the motor 60 to change the clamping force of the entire HMD 103 from the reference clamping force to the first clamping force (Step 110). At this time, the mounting band 20 contracts, the pair of second spring members 2 extend, and the clamping force changes with the first clamping force.

The first clamping force is clamping force stronger than the reference clamping force. FIG. 19 shows an example in a case where the acceleration in the gravity direction has exceeded the first range because the user walked. In this case, the control unit 62 changes the clamping force of the entire HMD 103 from the reference clamping force to the first clamping force.

This first clamping force is prestored in the storage unit 63 as a default value, considering the total weight of the HMD 103. For example, in a case where the total weight of the HMD 103 is relatively large, the first clamping force is set to be relatively strong force, and in a case where the total weight of the HMD 103 is relatively small, the first clamping force is set to be relatively weak force. It should be noted that the same applies to second clamping force to be described later.

Moreover, the first clamping force may be changed by a control unit 62 in accordance with reference clamping force. In this case, in a case where the reference clamping force is relatively strong, the first clamping force is set to be relatively strong force, and in a case where the reference clamping force is relatively weak, the first clamping force is set to be relatively weak force. It should be noted that the same applies to second clamping force to be described later.

In a case where the acceleration in the gravity direction has exceeded the first range and the clamping force of the entire HMD 103 has already been changed to the first clamping force (YES in Step 109), the control unit 62 proceeds to Step 111. In Step 111, the control unit 62 determines whether the acceleration in the gravity direction exceeds a second range centered at the gravitational acceleration 1G. The second range is, for example, a b-b′ range centered at the gravitational acceleration 1G as shown in FIG. 19.

This second range is a range larger than the first range and values (absolute values) of b and b′ are set to values (absolute values) of a and a′.

In a case where the acceleration in the gravity direction exceeds the second range (YES in Step 111), the control unit 62 determines whether the clamping force of the entire HMD 103 has not yet been changed to the second clamping force (Step 112). In a case where the clamping force of the entire HMD 103 has not yet been changed to the second clamping force (NO in Step 112), the control unit 62 drives the motor 60 to change the clamping force of the entire HMD 103 from the first clamping force to the second clamping force (Step 113). At this time, the mounting band 20 contracts, the pair of second spring members 2 extend, and the clamping force changes to the second clamping force.

The second clamping force is clamping force clamping force than the first clamping force. FIG. 19 shows an example in a case where the acceleration in the gravity direction has exceeded the second range because the walking user started to run. In this case, the control unit 62 changes the clamping force of the entire HMD 103 from the first clamping force to the second clamping force.

In Step 108, in a case where the acceleration in the gravity direction is within the first range (NO in Step 108), the control unit 62 determines whether the acceleration in the gravity direction has continuously been within the first range for a predetermined time (e.g., approximately 5 seconds to 10 seconds) or more (Step 114).

In a case where the acceleration in the gravity direction has continuously been within the first range for the predetermined time or more (YES in Step 114), the control unit 62 determines whether the clamping force of the entire HMD 103 has been changed to the first clamping force or the second clamping force (Step 115). In a case where the clamping force of the entire HMD 103 has been changed to the first clamping force or the second clamping force (YES in Step 115), the control unit 62 drives the motor 60 to return the clamping force of the entire HMD 103 to the reference clamping force from the first clamping force or the second clamping force (Step 116). At this time, the mounting band 20 extends, the pair of second spring members 2 contracts, and the clamping force returns to the reference clamping force.

FIG. 19 shows an example in a case where the acceleration in the gravity direction has been continuously within the first range for the predetermined time or more because the user stopped running. In this case, the control unit 62 returns the clamping force of the entire HMD 103 to the reference clamping force from the second clamping force.

It should be noted that in a case where the determination in Step 111 is negative (NO in Step 111) after Step 110, in a case where the determination in Step 112 is positive (YES in Step 112), or after Step 113, the control unit 62 proceeds to Step 117. Similarly, in a case where the determination in Step 114 is negative (NO in Step 114), in a case where the determination in Step 115 is negative (NO in Step 115), or after Step 116, the control unit 62 proceeds to Step 117.

In Step 117, the control unit 62 determines whether the operation unit 65 has been operated (corresponding to a case where the operation unit 65 has been operated again after the reference clamping force setting). In a case where the operation unit 65 has been operated (YES in Step 117), the control unit 62 returns to Step 102 and drives the motor 60 to adjust the clamping force of the entire HMD 103 in accordance with the operation of the operation unit 65. In a case where the operation unit 65 has not been operated (NO in Step 117), the control unit 62 returns to Step 107 and acquires the information regarding the acceleration in the gravity direction again.

<Actions, Etc.>

Next, actions, etc. in the HMD 103 according to the fourth embodiment will be described. In the description here, which direction of the three axial directions, the gravity direction (Z-axis direction), the left-right direction (X-axis direction), and the front-rear direction (Y-axis direction), the HMD 103 is easily displaced when the user moves or the like will be first described.

The inventor of the present technology had a plurality of users wear test HMDs and take prescribed test behaviors. Then, the inventor of the present technology measured displacement of the display unit 12 in each of the three axial directions before and after the test behaviors. As a result, the displacement in the gravity direction was 1.0 mm on average and 4.3 mm at the maximum. Moreover, the displacement in the left-right direction is 0.3 mm on average and 1.4 mm at the maximum. It should be noted that the displacement in the front-rear direction did hardly occur for the structure of the HMD.

It can be seen from this result that the most important direction that should be sensed by the inertial sensor 63 is the gravity direction. Therefore, in the HMD 103 according to the fourth embodiment, the inertial sensor 63 detects at least the acceleration in the gravity direction and the control unit 62 causes the mounting band 20 to extend and contract on the basis of the acceleration. Accordingly, the displacement of the HMD 103 can be suitably prevented. Moreover, the displacement of the HMD 103 is automatically prevented by the control unit 62, and therefore the user does not need to perform troublesome operations.

Moreover, in the fourth embodiment, the worm drive 61 and the worm wheel 133 are used as the mechanism that causes the mounting band 20 to extend and contract. By setting the speed reduction ratio of this worm drive 61 to be 1/40 or less, the self-lock function is achieved. This self lock mechanism 40 makes the rotation restriction member 43 unnecessary in the fourth embodiment, and the lock mechanism 40 can be simplified. Moreover, since the motor 60 does not reversely rotate due to this self-lock mechanism 40, the motor 60 does not consume electric power outside the driving time, and the power consumption can be thus reduced.

Moreover, in the fourth embodiment, the thresholds to be compared with the acceleration in the gravity direction have been set stepwisely (first range, second range) and the clamping force of the HMD 103 has also been set stepwisely (first clamping force, second clamping force). Accordingly, displacement prevention and mounting comfortability for the HMD 103 can be both achieved.

It should be noted that in the fourth embodiment, the thresholds and the clamping force of the HMD 103 to be compared with the acceleration in the gravity direction are in two steps, and they may be a single step or may be three or more steps.

Moreover, in the fourth embodiment, after the temporary mounting of the HMD 103, the clamping force of the entire HMD 103 can be automatically adjusted by the user merely operating the operation unit 65 (e.g., a push button type), and therefore the HMD 103 can be easily mounted.

### Fifth Embodiment

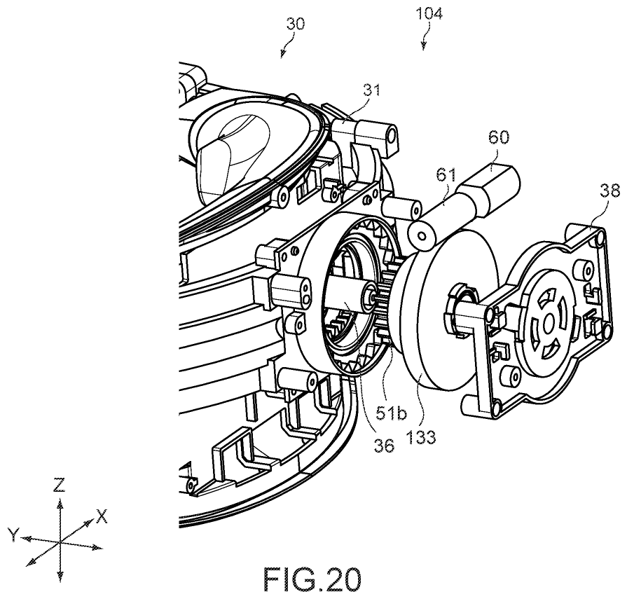

Next, a fifth embodiment of the present technology will be described. In the description of the fifth embodiment, points different from those of the fourth embodiment will be mainly described. FIG. 20 is an exploded perspective view as the respective parts in the rear portion of the rear block main body 31 are viewed from the rear side in an HMD 104 according to the fifth embodiment.

As shown in FIG. 20, in the HMD 104 according to the fifth embodiment, a pinion gear 51a and a worm wheel 133 are integrally formed. Moreover, in the fifth embodiment, the lock mechanism 40 is not provided. Specifically, in the fifth embodiment, the first biasing spring 41, the clutch 42, the rotation restriction member 43, the pair of lock levers 44, the pair of torsion springs 45, the second biasing spring 46, the cancel button 47, and the like are not provided. Thus, in the fifth embodiment, the unlocked state and the locked state do not exist.

In addition, in the fifth embodiment, the pair of first spring members 1, 1a are also omitted.

The control unit 62 may perform the same processing as the processing of the fourth embodiment shown in FIG. 18. It should be noted that in the fifth embodiment, the operation when the user mounts the HMD 104 is different. That is, although it is necessary to manually extend the mounting band 20 until the temporary mounting in the fourth embodiment, it is unnecessary in the fifth embodiment.

Specifically, in the fifth embodiment, when mounting the HMD 104, the user operates the operation unit 65 to thereby drive the motor 60 to cause the mounting band 20 to extend and temporarily mounts the HMD 104 on the head with a size with which the head can be put therein. Then, the user operates the operation unit 65 to thereby drive the motor 60 to cause the mounting band 20 extend and contract. At this time, the mounting band 20 extends and contracts, the pair of second spring members 2 extends and contracts, and the clamping force of the entire HMD 104 is adjusted. Then, the user only needs to cancel the operation of the operation unit 65 at the time at which the clamping force of the entire HMD 104 becomes suitable clamping force.

That is, in the fifth embodiment, the extension and contraction of the HMD 104 until the HMD 104 is temporarily mounted are also performed by the driving of the motor 60, and therefore it is necessary to provide the pair of first spring members 1, 1a.

In the fifth embodiment, at the time of mounting the HMD 104, the user merely operates the operation unit 65 (e.g., a push button type) to thereby automatically adjust the clamping force of the entire HMD 100, and therefore the HMD 100 is easily mounted. Moreover, in the fifth embodiment, since the respective members can be omitted, the structure is simplified and a compact and lightweight HMD can also be provided.

### <<Various Modified Examples>

The present technology may also take the following configurations.

(1) A head-mounted device, including:

a front block that is mounted on a front side of a head;

a mounting band including a pair of left and right band portions that are mounted on left and right sides of the head and a rear block that is mounted on a rear side of the head and movable relative to the pair of band portions, the mounting band being capable of extending and contracting due to the movement of the rear block relative to the pair of band portions;

a pair of left and right first elastic members that generate tensile force to cause the mounting band to contract; and

a pair of left and right second elastic members provided between the front block and the pair of band portions.

(2) The head-mounted device according to (1), in which

the pair of first elastic members are provided between the pair of band portions and the rear block.

(3) The head-mounted device according to (1), in which

the pair of first elastic members are provided between the front block and the rear block.

(4) The head-mounted device according to any one of (1) to (3), in which

a spring constant of the first elastic member is different from a spring constant of the second elastic member.

(5) The head-mounted device according to (4), in which

the spring constant of the second elastic member is higher than the spring constant of the first elastic member.

(6) The head-mounted device according to (5), in which

the spring constant of the second elastic member is twice or more as large as the spring constant of the first elastic member.

(7) The head-mounted device according to any one of (1) to (5), in which

the rear block includes a lock mechanism that switches between an unlocked state in which the extension and contraction of the mounting band due to the movement of the rear block relative to the pair of band portions are allowed and a locked state in which the extension and contraction of the mounting band due to the relative movement are restricted.

(8) The head-mounted device according to (7), in which

the rear block includes an operation unit for causing the mounting band to extend and contract, and

the lock mechanism switches the unlocked state to the locked state in accordance with an operation of the operation unit.

(9) The head-mounted device according to (8), in which

the lock mechanism includes a restriction member that allows, in the locked state, the extension and contraction of the mounting band that are performed in accordance with an operation of the operation unit while restricting the extension and contraction of the mounting band that are not performed in accordance with an operation of the operation unit.

(10) The head-mounted device according to (9), in which

the operation unit includes a rotatable dial, the head-mounted device further including

an extension and contraction mechanism that includes a pinion gear rotatable in accordance with a rotation of the dial and racks, which are respectively provided in the pair of band portions and engaged with the pinion gear, and causes the mounting band to extend and contract in accordance with a rotation of the dial.

(11) The head-mounted device according to (10), in which

the restriction member restricts, in the locked state, the rotation of the pinion gear to thereby restrict the extension and contraction of the mounting band during non-rotation of the dial and allows the rotation of the pinion gear to thereby allow the extension and contraction of the mounting band during rotation of the dial.

(12) The head-mounted device according to (11), in which

the lock mechanism further includes a clutch that is capable of being engaged with the restriction member, is located at a first position not engaged with the restriction member and allows the rotation of the pinion gear in the unlocked state, and moves from the first position to a second position, is engaged with the rotation restriction member in accordance with a rotation of the dial in the unlocked state, and switches the unlocked state to the locked state.

(13) The head-mounted device according to (12), in which

the lock mechanism further includes a switching mechanism that moves the clutch from the first position to the second position in accordance with a rotation of the dial.

(14) The head-mounted device according to (12), in which

the clutch is rotatable integrally with the pinion gear,

the restriction member is rotatable integrally with the clutch in a state engaged with the clutch, and

the dial is capable of rotating the rotation restriction member by rotation.

(15) The head-mounted device according to (14), in which

the lock mechanism further includes a tooth portion provided in the rear block, and

the restriction member includes a hook portion that is engaged with the tooth portion, restricts the extension and contraction of the mounting band in such a manner that the rotation of the restriction member is restricted in an engaged state in which the hook portion is engaged with the tooth portion, and allows the extension and contraction of the mounting band in such a manner that the rotation of the restriction member is allowed in a cancelled state in which the engagement is cancelled.

(16) The head-mounted device according to (15), in which

the lock mechanism further includes a cancel mechanism that puts the hook portion in the engaged state during non-rotation of the dial and puts the hook portion in the cancelled state during rotation of the dial.

(17) The head-mounted device according to (1), further including:

an inertial sensor that acquires inertial information of a gravity direction;

a drive unit that generates driving force to cause the mounting band to extend and contract; and

a control unit that controls the drive unit on the basis of the inertial information to cause the mounting band extend and contract.

(18) The head-mounted device according to (17), further including:

a worm drive provided in a drive unit; and

a worm wheel that is engaged with the worm drive and causes the mounting band to extend and contract by rotation.

(19) A head-mounted device, including:

a front block that is mounted on a front side of a head;

a mounting band including a pair of left and right band portions that are mounted on left and right sides of the head and a rear block that is mounted on a rear side of the head and movable relative to the pair of band portions, the mounting band being capable of extending and contracting due to the movement of the rear block relative to the pair of band portions;

an operation unit provided in the front block;

a pair of left and right link members movable along the pair of band portions in accordance with an operation of the operation unit; and

a pair of left and right elastic members provided between the pair of link members and the rear block.

(20) A head-mounted device, further including:

a mounting band capable of extending and contracting;

an inertial sensor that acquires inertial information of a gravity direction;

a drive unit that generates driving force to cause the mounting band to extend and contract; and

a control unit that controls the drive unit on the basis of the inertial information to cause the mounting band extend and contract.

### REFERENCE SIGNS LIST

1, 1a first spring member
2 second spring member
10 front block
20 mounting band
21 band portion
30 rear block
33 dial
40 lock mechanism
42 clutch
43 rotation restriction member
44 lock lever
51 pinion gear portion
100 to 104 HMD

1. A head-mounted device, comprising:
a front block that is mounted on a front side of a head;
a mounting band including a pair of left and right band portions that are mounted on left and right sides of the head and a rear block that is mounted on a rear side of the head and movable relative to the pair of band portions, the mounting band being capable of extending and contracting due to the movement of the rear block relative to the pair of band portions;
a pair of left and right first elastic members that generate tensile force to cause the mounting band to contract; and
a pair of left and right second elastic members provided between the front block and the pair of band portions.

2. The head-mounted device according to claim 1, wherein
the pair of first elastic members are provided between the pair of band portions and the rear block.

3. The head-mounted device according to claim 1, wherein
the pair of first elastic members are provided between the front block and the rear block.

4. The head-mounted device according to claim 1, wherein
a spring constant of the first elastic member is different from a spring constant of the second elastic member.

5. The head-mounted device according to claim 4, wherein
the spring constant of the second elastic member is higher than the spring constant of the first elastic member.

6. The head-mounted device according to claim 5, wherein
the spring constant of the second elastic member is twice or more as large as the spring constant of the first elastic member.

7. The head-mounted device according to claim 1, wherein
the rear block includes a lock mechanism that switches between an unlocked state in which the extension and contraction of the mounting band due to the movement of the rear block relative to the pair of band portions are allowed and a locked state in which the extension and contraction of the mounting band due to the relative movement are restricted.

8. The head-mounted device according to claim 7, wherein
the rear block includes an operation unit for causing the mounting band to extend and contract, and
the lock mechanism switches the unlocked state to the locked state in accordance with an operation of the operation unit.

9. The head-mounted device according to claim 8, wherein
the lock mechanism includes a restriction member that allows, in the locked state, the extension and contraction of the mounting band that are performed in accordance with an operation of the operation unit while restricting the extension and contraction of the mounting band that are not performed in accordance with an operation of the operation unit.

10. The head-mounted device according to claim 9, wherein
the operation unit includes a rotatable dial, the head-mounted device further comprising
an extension and contraction mechanism that includes a pinion gear rotatable in accordance with a rotation of the dial and racks, which are respectively provided in the pair of band portions and engaged with the pinion gear, and causes the mounting band to extend and contract in accordance with a rotation of the dial.

11. The head-mounted device according to claim 10, wherein
the restriction member restricts, in the locked state, the rotation of the pinion gear to thereby restrict the extension and contraction of the mounting band during non-rotation of the dial and allows the rotation of the pinion gear to thereby allow the extension and contraction of the mounting band during rotation of the dial.

12. The head-mounted device according to claim 11, wherein
the lock mechanism further includes a clutch that is capable of being engaged with the restriction member, is located at a first position not engaged with the restriction member and allows the rotation of the pinion gear in the unlocked state, and moves from the first position to a second position, is engaged with the rotation restriction member in accordance with a rotation of the dial in the unlocked state, and switches the unlocked state to the locked state.

13. The head-mounted device according to claim 12, wherein
the lock mechanism further includes a switching mechanism that moves the clutch from the first position to the second position in accordance with a rotation of the dial.

14. The head-mounted device according to claim 12, wherein
the clutch is rotatable integrally with the pinion gear,
the restriction member is rotatable integrally with the clutch in a state engaged with the clutch, and
the dial is capable of rotating the rotation restriction member by rotation.

15. The head-mounted device according to claim 14, wherein
the lock mechanism further includes a tooth portion provided in the rear block, and
the restriction member includes a hook portion that is engaged with the tooth portion, restricts the extension and contraction of the mounting band in such a manner that the rotation of the restriction member is restricted in an engaged state in which the hook portion is engaged with the tooth portion, and allows the extension and contraction of the mounting band in such a manner that the rotation of the restriction member is allowed in a cancelled state in which the engagement is cancelled.

16. The head-mounted device according to claim 15, wherein
the lock mechanism further includes a cancel mechanism that puts the hook portion in the engaged state during non-rotation of the dial and puts the hook portion in the cancelled state during rotation of the dial.

17. The head-mounted device according to claim 1, further comprising:
an inertial sensor that acquires inertial information of a gravity direction;
a drive unit that generates driving force to cause the mounting band to extend and contract; and
a control unit that controls the drive unit on a basis of the inertial information to cause the mounting band extend and contract.

18. The head-mounted device according to claim 17, further comprising:
a worm drive provided in a drive unit; and
a worm wheel that is engaged with the worm drive and causes the mounting band to extend and contract by rotation.

19. A head-mounted device, comprising:
a front block that is mounted on a front side of a head;
a mounting band including a pair of left and right band portions that are mounted on left and right sides of the head and a rear block that is mounted on a rear side of the head and movable relative to the pair of band portions, the mounting band being capable of extending and contracting due to the movement of the rear block relative to the pair of band portions;
an operation unit provided in the front block;
a pair of left and right link members movable along the pair of band portions in accordance with an operation of the operation unit; and
a pair of left and right elastic members provided between the pair of link members and the rear block.

20. A head-mounted device, further comprising:
a mounting band capable of extending and contracting;
an inertial sensor that acquires inertial information of a gravity direction;
a drive unit that generates driving force to cause the mounting band to extend and contract; and
a control unit that controls the drive unit on a basis of the inertial information to cause the mounting band extend and contract.
